(19) United States
(12) Patent Application Publication
(10) Pub. No.: US 2014/0049529 A1
(43) Pub. Date: Feb. 20, 2014

(54) METHOD FOR DRIVING PLASMA DISPLAY PANEL AND PLASMA DISPLAY DEVICE

(71) Applicants: Takateru Sawada, Osaka (JP); Takahiko Origuchi, Osaka (JP); Kosuke Makino, Osaka (JP); Hidehiko Shoji, Osaka (JP)

(72) Inventors: Takateru Sawada, Osaka (JP); Takahiko Origuchi, Osaka (JP); Kosuke Makino, Osaka (JP); Hidehiko Shoji, Osaka (JP)

(73) Assignee: PANASONIC CORPORATION, Kadoma-shi, Osaka (JP)

(21) Appl. No.: 14/001,457

(22) PCT Filed: Sep. 26, 2012
(86) PCT No.: PCT/JP2012/006114

§ 371 Date: Aug. 23, 2013

(30) Foreign Application Priority Data
Sep. 26, 2011 (JP) 2011-208589
Sep. 26, 2011 (JP) 2011-208591

(51) Int. Cl. G09G 3/296

(52) U.S. Cl. CPC G09G 3/296
USPC 345/208

(57) ABSTRACT

In a plasma display apparatus, the address discharge is stabilized, the contrast is sharpened, and the image display quality is improved. A first up-ramp waveform voltage is applied to the scan electrode, and then a voltage causing no discharge to the scan electrode is applied to the scan electrode, in the sustain period of a weak-discharge sustain operation subfield in a discharge cell that is to be subjected to a forced initializing operation in the initializing period of the subfield immediately after the weak-discharge sustain operation subfield. A second up-ramp waveform voltage is applied to the scan electrode after generation of the first up-ramp waveform voltage, in the sustain period of the weak-discharge sustain-operation subfield in a discharge cell that is to be subjected to a selective initializing operation in the initializing period of the subfield immediately after the weak-discharge sustain-operation subfield.

### TECHNICAL FIELD

The present invention relates to a plasma display apparatus including an alternating-current surface discharge type plasma display panel, and a driving method of the plasma display panel.

### BACKGROUND ART

An alternating-current surface discharge type panel typical as a plasma display panel (hereinafter referred to as “panel”) has many discharge cells between a front substrate and a rear substrate that are faced to each other.

The front substrate includes a plurality of display electrode pairs each of which is formed of a pair of scan electrode and sustain electrode, and the display electrode pairs are disposed in parallel on a front glass substrate. The rear substrate includes a plurality of data electrodes disposed in parallel on a rear glass substrate.

A phosphor of each of red (R), green (G), and blue (B) is applied to the inside of each discharge cell, and discharge gas is filled in each discharge cell. In each discharge cell, ultraviolet rays are emitted by gas discharge, and excite the phosphor to emit light.

A subfield method is generally used as a method of displaying an image in an image display region of the panel by combining binary controls of light emission and no light emission in a discharge cell.

In the subfield method, one field is divided into a plurality of subfields of different light emission luminances. In each discharge cell, light emission and no light emission of each subfield is controlled with a combination corresponding to a desired gradation value. Thus, light is emitted at a brightness corresponding to the desired gradation value in each discharge cell, and a color image using a combination of various gradation values is displayed in the image display region of the panel.

In the subfield method, an initializing operation, an address operation, and a sustain operation are performed generally in each subfield.

The initializing operation includes a forced initializing operation and a selective initializing operation. In the forced initializing operation, initializing discharge is caused in a discharge cell regardless of the presence or absence of discharge in the immediately preceding subfield. In the selective initializing operation, initializing discharge is caused only in the discharge cell having undergone address discharge in the immediately preceding subfield.

As one of subfield methods, a driving method is disclosed where the forced initializing operation is performed using a gently varying ramp waveform voltage and the number of forced initializing operations is set at one per field (for example, Patent Literature 1). In this driving method, the luminance (hereinafter referred to as “luminance of black level”) in a black displaying discharge cell is decreased, thereby sharpening the contrast of the display image.

A driving method is disclosed where display electrode pairs in the panel are classified into n display electrode pair groups, and the number of forced initializing operations is set at one for n fields (for example, Patent Literature 2). In this driving method, the luminance of black level is further decreased, thereby further sharpening the contrast of the display image.

A driving method is disclosed where one field includes a subfield having a sustain period in which strong discharge by a sustain pulse is not caused and only weak discharge by a ramp waveform is caused (for example, Patent Literature 3). In this driving method, the luminance of the next higher level than the black level is decreased, and more gradations can be displayed on the panel.

### CITATION LIST

### Patent Literature

PTL 1 Unexamined Japanese Patent Publication No. 2000-242224
PTL 2 Unexamined Japanese Patent Publication No. 2010-266651
PTL 3 International Patent Publication No. 08/152,808

### SUMMARY OF THE INVENTION

In a driving method of a plasma display panel and a plasma display apparatus of the present invention, one field includes a plurality of subfields having an initializing period, address period, and sustain period. The subfields include a weak-discharge sustain operation subfield that undergoes no sustain pulse in the sustain period. In the initializing period of the subfield immediately after the weak-discharge sustain operation subfield, at least one of the following initializing operations is performed:
a forced initializing operation of causing initializing discharge in a discharge cell regardless of the presence or absence of discharge in the weak-discharge sustain operation subfield; and
a selective initializing operation of causing initializing discharge only in the discharge cell having undergone address discharge in the weak-discharge sustain operation subfield.
   In the discharge cell that undergoes the forced initializing operation in the initializing period of the subfield immediately after the weak-discharge sustain operation subfield, in the sustain period of the weak-discharge sustain operation subfield, a first up-ramp waveform voltage which increases from a base potential to a first voltage is applied to the scan electrode, and then a voltage that does not cause discharge is applied to the scan electrode. In the discharge cell that undergoes the selective initializing operation in the initializing period of the subfield immediately after the weak-discharge sustain operation subfield, in the sustain period of the weak-discharge sustain operation subfield, a second up-ramp waveform voltage which increases from the base potential to a second voltage is applied to the scan electrode after generation of the first up-ramp waveform voltage.

Thus, in a driving method of a plasma display panel and a plasma display apparatus, the contrast of a display image is increased by further finely displaying gradations in a dark region in the display image and reducing the luminance of black level, and address discharge can be caused stably.

In this driving method, the base potential may be applied to the data electrode when the first up-ramp waveform voltage is applied to the scan electrode, and a third up-ramp waveform voltage may be applied to the data electrode when the second up-ramp waveform voltage is applied to the scan electrode.

In this driving method, the second voltage may be set at a voltage of the first voltage or lower.

In this driving method, a down-ramp waveform voltage may be applied to the scan electrode in the initializing period, and the gradient of the down-ramp waveform voltage in the initializing period of the subfield immediately after the weak-discharge sustain operation subfield may be gentler than that of the down-ramp waveform voltage in the initializing periods of the other subfields.

### BRIEF DESCRIPTION OF DRAWINGS

FIG. 1 is an exploded perspective view showing an example of a structure of a panel used in a plasma display apparatus in accordance with a first exemplary embodiment of the present invention.

FIG. 2 is a diagram showing an example of an electrode array of the panel used in the plasma display apparatus in accordance with the first exemplary embodiment of the present invention.

FIG. 3 is a diagram for schematically showing an example of a driving voltage waveform to be applied to each electrode of the panel in the plasma display apparatus in accordance with the first exemplary embodiment of the present invention.

FIG. 4 is a diagram showing an example of a generation pattern of a forced initializing operation and a selective initializing operation in accordance with the first exemplary embodiment of the present invention.

FIG. 5 is a diagram for schematically showing an example of circuit blocks constituting the plasma display apparatus in accordance with the first exemplary embodiment of the present invention.

FIG. 6 is a circuit diagram for schematically showing a configuration example of a scan electrode driver circuit of the plasma display apparatus in accordance with the first exemplary embodiment of the present invention.

FIG. 7 is a circuit diagram for schematically showing a configuration example of a sustain electrode driver circuit of the plasma display apparatus in accordance with the first exemplary embodiment of the present invention.

FIG. 8 is a circuit diagram for schematically showing a configuration example of a data electrode driver circuit of the plasma display apparatus in accordance with the first exemplary embodiment of the present invention.

FIG. 9 is a circuit diagram for schematically showing a configuration example of a scan electrode driver circuit of a plasma display apparatus in accordance with a second exemplary embodiment of the present invention.

FIG. 10 is a timing chart showing an example of operations of the scan electrode driver circuit and data electrode driver circuit in accordance with the second exemplary embodiment of the present invention.

FIG. 11 is a diagram for schematically showing an example of driving voltage waveforms in accordance with a third exemplary embodiment of the present invention.

FIG. 12 is a diagram for schematically showing an example of driving voltage waveforms in accordance with a fourth exemplary embodiment of the present invention.

FIG. 13 is a diagram for schematically showing an example of driving voltage waveforms in accordance with a fifth exemplary embodiment of the present invention.

FIG. 14 is a diagram for schematically showing another example of driving voltage waveforms in accordance with the fifth exemplary embodiment of the present invention.

### DESCRIPTION OF EMBODIMENTS

A plasma display apparatus in accordance with exemplary embodiments of the present invention will be described hereinafter with reference to the accompanying drawings.

### First Exemplary Embodiment

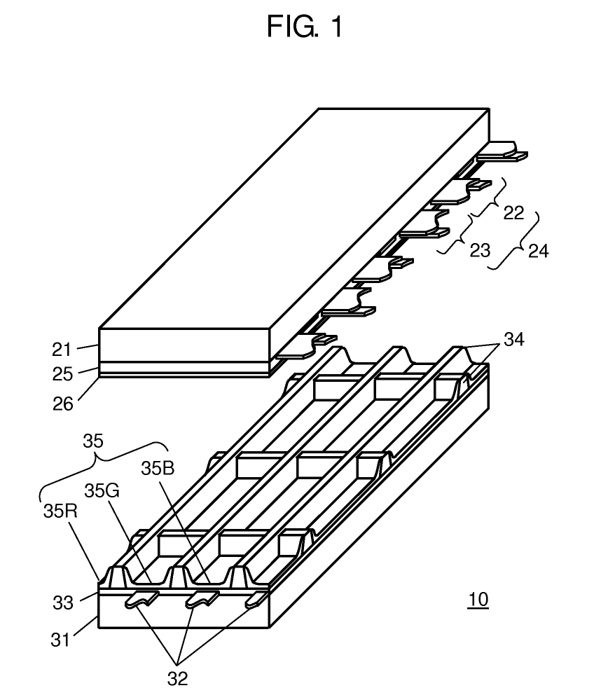

FIG. 1 is an exploded perspective view showing an example of a structure of a panel used in a plasma display apparatus in accordance with a first exemplary embodiment of the present invention.

A plurality of display electrode pairs 24 formed of scan electrodes 22 and sustain electrodes 23 is disposed on glass-made front substrate 21. Dielectric layer 25 is formed so as to cover display electrode pairs 24, and protective layer 26 is formed on dielectric layer 25. Protective layer 26 is made of magnesium oxide as a material of high electron emission performance in order to facilitate occurrence of discharge. Front substrate 21 serves as an image display surface on which an image is displayed.

A plurality of data electrodes 32 is formed on rear substrate 31, dielectric layer 33 is formed so as to cover data electrodes 32, and mesh barrier ribs 34 are formed on dielectric layer 33. Phosphor layers 35R for emitting light of red color (R), phosphor layers 35G for emitting light of green color (G), and phosphor layers 35B for emitting light of blue color (B) are formed on the side surfaces of barrier ribs 34 and on dielectric layer 33. Phosphor layers 35R, phosphor layers 35G, and phosphor layers 35B are collectively referred to as phosphor layers 35.

Front substrate 21 and rear substrate 31 are faced to each other so that display electrode pairs 24 cross data electrodes 32 with a micro space sandwiched between them, and a discharge space is disposed in the clearance between front substrate 21 and rear substrate 31. The outer periphery of the discharge space is sealed by a sealing material such as glass frit. The discharge space is filled with mixed gas of neon and xenon as discharge gas, for example.

The discharge space is partitioned into a plurality of sections by barrier ribs 34. Discharge cells as light emitting elements constituting a pixel are formed in the intersecting parts of display electrode pairs 24 and data electrodes 32.

Then, discharge is caused in these discharge cells, and light is emitted (lighting in the discharge cells) on phosphor layers 35, thereby displaying a color image on panel 10.

The structure of panel 10 is not limited to the above-mentioned one, but may be a structure including striped barrier ribs, for example.

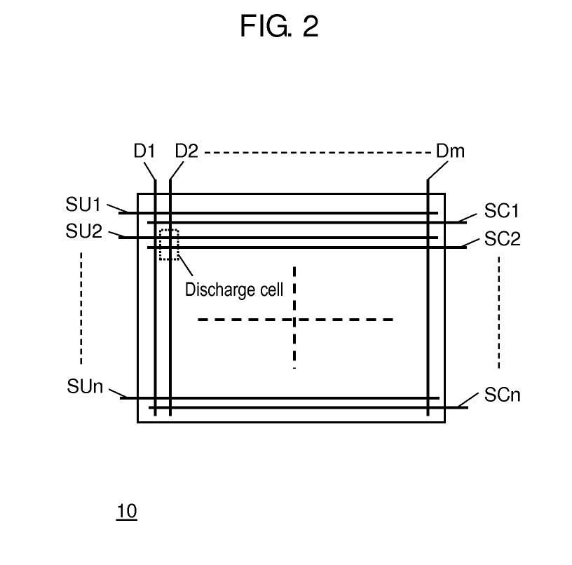

FIG. 2 is a diagram showing an example of an electrode array of the panel used in the plasma display apparatus in accordance with the first exemplary embodiment of the present invention.

Panel 10 has n scan electrodes SC1 through SCn (scan electrodes 22 in FIG. 1) and n sustain electrodes SU1 through SUn (sustain electrodes 23 in FIG. 1) both extended in the row direction (horizontal direction, line direction), and m data electrodes D1 through Dm (data electrodes 32 in FIG. 1) extended in the column direction (vertical direction).

One discharge cell as a light emitting element is formed in the region where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3=5760 and n is 1080.

Next, an example of driving voltage waveforms generated by the plasma display apparatus of the present exemplary embodiment is described.

The plasma display apparatus of the present exemplary embodiment drives panel 10 by a subfield method. In this subfield method, the plasma display apparatus divides one field of an image signal into a plurality of subfields on the time axis. In other words, one field is formed of a plurality of subfields having different emission luminances (luminance weights).

Each subfield has an initializing period, address period, and sustain period. In each discharge cell, light emission and no light emission in each subfield is controlled based on the image signal. Thus, light is emitted at a brightness corresponding to the image signal in each discharge cell, and an image is displayed in the image display region of panel 10.

In the initializing period, an initializing operation of causing the initializing discharge in each discharge cell and producing wall charge required for the subsequent address operation in the discharge cell is performed. In addition, priming particles (charged particles that support occurrence of discharge) required for an address operation are generated in the discharge cells.

The initializing operation includes “forced initializing operation” and “selective initializing operation”. In the forced initializing operation, initializing discharge is caused forcibly in discharge cells regardless of the presence or absence of discharge in the immediately preceding subfield. In the selective initializing operation, initializing discharge is selectively caused only in the discharge cell having undergone address discharge in the address period in the immediately preceding subfield.

In the present exemplary embodiment, “specific-cell initializing subfield” and “selective initializing subfield” are disposed in one field. The specific-cell initializing subfield has an initializing period in which the forced initializing operation is performed in a specific discharge cell and the selective initializing operation is performed in the other discharge cells. The selective initializing subfield has an initializing period in which the selective initializing operation is performed in all discharge cells.

In the address period, an address operation of causing address discharge in the discharge cell to emit light is performed.

In the sustain period of the present exemplary embodiment, one of “strong-discharge sustain operation” and “weak-discharge sustain operation” is performed. In the strong-discharge sustain operation, sustain pulses are alternately applied to scan electrodes 22 and sustain electrodes 23, and strong discharge (sustain discharge) is caused in the discharge cell having undergone address discharge. In the weak-discharge sustain operation, no sustain pulse is generated, a gently increasing up-ramp waveform voltage is applied to scan electrodes 22, and weak discharge (erasing discharge) is caused in the discharge cell having undergone address discharge.

Hereinafter, a subfield where the strong-discharge sustain operation is performed in the sustain period is referred to as “strong-discharge sustain operation subfield”, and a subfield where the weak-discharge sustain operation is performed in the sustain period is referred to as “weak-discharge sustain operation subfield”.

The present exemplary embodiment describes the following example:
the first subfield (subfield SF1), of a plurality of subfields constituting one field, is set as a weak-discharge sustain operation subfield, and the other subfields (subfield SF2 and later) are set as strong-discharge sustain operation subfields.

The present exemplary embodiment describes the following example:
subfield SF2 is set as a specific-cell initializing subfield, and the other subfields (subfield SF1, and subfield SF3 and later) are set as selective initializing subfields.

Therefore, in the examples of the present exemplary embodiment, subfield SF1 is a selective initializing subfield and weak-discharge sustain operation subfield, subfield SF2 is a specific-cell initializing subfield and strong-discharge sustain operation subfield, and subfield SF3 and later are selective initializing subfields and strong-discharge sustain operation subfields.

In this configuration, the number of light emissions caused by the forced initializing operation is only one for a plurality of fields (for example, one for five fields), so that the luminance of black level can be reduced and an image of high contrast can be displayed on panel 10.

The present exemplary embodiment describes the following example:
one field is constituted by 10 subfields (subfields SF1 through SF10), and luminance weights of (1, 2, 3, 6, 11, 18, 30, 44, 60, 80) are set to the subfields, respectively.
   Subfield SF1 as a weak-discharge sustain operation subfield is a subfield having the smallest luminance weight.

In the sustain period of each subfield, light emission is caused at a luminance corresponding to the magnitude of the luminance weight. However, it is simply indicated that emission luminance of luminance weight “1” is lower than that of luminance weight “2”, and it is not indicated that light is emitted in subfield SF1 of luminance weight “1” at a luminance half that in subfield SF2 of luminance weight “2”.

In the present invention, the number of subfields in one field and the luminance weight of each subfield are not limited to the above-mentioned values.

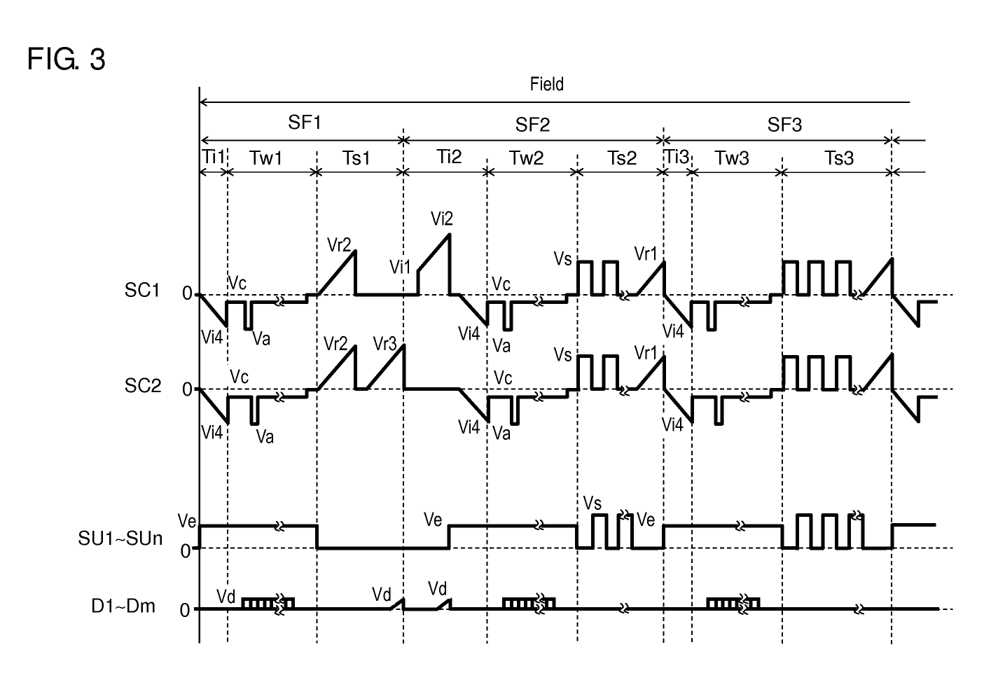

FIG. 3 is a diagram for schematically showing an example of a driving voltage waveform to be applied to each electrode of panel 10 in the plasma display apparatus in accordance with the first exemplary embodiment of the present invention.

FIG. 3 shows driving voltage waveforms applied to scan electrode SC1 that firstly undergoes an address operation in the address period, scan electrode SC2 that secondly undergoes the address operation in the address period, sustain electrodes SU1 through SUn, and data electrodes D1 through Dm. Each of scan electrode SCi, sustain electrode SUi, and data electrode Dk discussed later means an electrode that is selected from each kind of electrode based on image data (which indicates light emission or no light emission in each subfield).

FIG. 3 shows driving voltage waveforms in each of subfields SF1 through SF3.

In the example of FIG. 3, in initializing period Ti2 of subfield SF2 as a specific-cell initializing subfield, a driving voltage waveform for performing a forced initializing operation is applied to scan electrode SC1, and a driving voltage waveform for performing a selective initializing operation is applied to scan electrode SC2.

Hereinafter, “forced initializing operation is performed on scan electrode 22” indicates that a driving voltage waveform for performing the forced initializing operation is applied to scan electrode 22 and the forced initializing operation is performed in the discharge cell formed on the scan electrode 22. “Scan electrode 22 on which the forced initializing operation is performed” indicates scan electrode 22 to which a driving voltage waveform for performing the forced initializing operation is applied.

“Forced initializing operation is performed on scan electrode 22” indicates that a driving voltage waveform for performing the selective initializing operation is applied to scan electrode 22 and the selective initializing operation is performed in the discharge cell formed on the scan electrode 22. “Scan electrode 22 on which the selective initializing operation is performed” indicates scan electrode 22 to which a driving voltage waveform for performing the selective initializing operation is applied.

The shape of the driving voltage waveform applied to scan electrode SC1 in the initializing period in subfield SF2 as a specific-cell initializing subfield is different from those in subfield SF1, and subfield SF3 and later as selective initializing subfields.

In subfield SF4 and later, a driving voltage waveform substantially similar to that in subfield SF3 except for the number of generated sustain pulses is generated.

First, subfield SF1 as a selective initializing subfield and weak-discharge sustain operation subfield is described.

In initializing period Ti1 of subfield SF1 where the selective initializing operation is performed, voltage 0 (V) is applied to data electrodes D1 through Dm, and voltage Ve is applied to sustain electrodes SU1 through SUn. To scan electrodes SC1 through SCn, a down-ramp waveform voltage is applied which gently decreases from a voltage (e.g. voltage 0 (V)) lower than the discharge start voltage to a negative voltage Vi4.

While the down-ramp waveform voltage is applied to scan electrodes SC1 through SCn, feeble initializing discharge occurs between scan electrode SCi and sustain electrode SUi and between scan electrode SCi and data electrode Dk in the discharge cell having undergone sustain discharge in sustain period Ts10 (not shown) of immediately preceding subfield SF10.

By this initializing discharge, the excess part of the positive wall voltage that has been accumulated on data electrode Dk by the immediately preceding sustain discharge is discharged, thereby adjusting the wall voltage to a wall voltage appropriate for the address operation. The wall voltage on scan electrode SCi and the wall voltage on sustain electrode SUi are reduced. Thus, the wall voltage in the discharge cell is adjusted to a wall voltage appropriate for the address operation in subsequent address period Tw1. Furthermore, priming particles for supporting occurrence of address discharge are generated in the discharge cell.

The wall voltage on the electrodes means the voltage that is generated by the wall charge accumulated on a dielectric layer for covering the electrodes, a protective layer, and phosphor layers.

While, initializing discharge does not occur in the discharge cell having undergone no sustain discharge in sustain period Ts10 of immediately preceding subfield SF10.

After the voltage applied to scan electrode SC1 through SCn arrives at voltage Vi4, the voltage applied to scan electrode SC1 through SCn is set at voltage Vc in preparation for the subsequent address operation.

Thus, the selective initializing operation in initializing period Ti1 of subfield SF1 as a selective initializing subfield is completed. Then, in initializing period (selective initializing period) Ti1, initializing discharge is selectively caused in the discharge cell having undergone sustain discharge in sustain period Ts10 of the immediately preceding subfield (subfield SF10 here).

Thus, the selective initializing operation in initializing period Ti1 of subfield SF1 is completed.

Next, the address period is described.

In address period Tw1 of subfield SF1, voltage 0 (V) is applied to data electrodes D1 through Dm, voltage Ve is applied to sustain electrodes SU1 through SUn, and voltage Vc is applied to scan electrode SC1 through SCn.

Next, a scan pulse of negative polarity of negative voltage Va is applied to scan electrode SC1 of the first row. An address pulse of positive polarity of positive voltage Vd is applied to data electrode Dk of the discharge cell to emit light in the first row, of data electrodes D1 through Dm.

In the discharge cell existing in the intersecting part of data electrode Dk to which voltage Vd of the address pulse is applied and scan electrode SC1 to which voltage Va of the scan pulse is applied, discharge occurs between data electrode Dk and scan electrode SC1. This discharge also causes discharge between sustain electrode SU1 and scan electrode SC1. Thus, address discharge occurs in the discharge cell (to emit light) to which voltage Va of the scan pulse and voltage Vd of the address pulse are simultaneously applied.

In the discharge cell having undergone address discharge, positive wall voltage is accumulated on scan electrode SC1, negative wall voltage is accumulated on sustain electrode SU1, and negative wall voltage is also accumulated on data electrode Dk.

Thus, the address operation in the discharge cell of the first row is completed. In the discharge cell to which no address pulse has been applied, the voltage in the intersecting part of scan electrode SC1 and data electrode Dh does not exceed the discharge start voltage, so that address discharge does not occur. Here, data electrode Dh is one of data electrodes D1 through Dm, other than data electrode Dk.

Next, a scan pulse of voltage Va is applied to scan electrode SC2 of the second row, and an address pulse of voltage Vd is applied to data electrode Dk corresponding to the discharge cell to emit light in the second row. Address discharge occurs in the discharge cell of the second row to which a scan pulse and address pulse are applied simultaneously. No address discharge occurs in the discharge cell having undergone no address pulse. Thus, the address operation in the discharge cell of the second row is performed.

A similar address operation is sequentially performed until the discharge cell of the n-th row in the sequence of scan electrode SC3, scan electrode SC4, . . . , scan electrode SCn (not shown), and address period Tw1 of subfield SF1 is then completed. Thus, in address period Tw1, address discharge is selectively caused in the discharge cell to emit light, and wall charge for causing sustain discharge is produced in the discharge cell.

Thus, the address operation in address period Tw1 of subfield SF1 is completed. In the present invention, the sequence in which a scan pulse is applied to scan electrodes SC1 through SCn is not limited to the above-mentioned sequence. The sequence in which a scan pulse is applied to scan electrodes SC1 through SCn is set optionally in response to the specification of the plasma display apparatus.

Next, sustain period Ts1 of subfield SF1 is described.

In sustain period Ts1 of subfield SF1 as a weak-discharge sustain operation subfield, no sustain pulse is applied to scan electrodes SC1 through SCn and sustain electrodes SU1 through SUn, and an up-ramp waveform voltage is applied to scan electrodes SC1 through SCn, thereby performing the weak-discharge sustain operation.

Specifically, voltage 0 (V) is applied to sustain electrodes SU1 through SUn and data electrodes D1 through Dm, and a first up-ramp waveform voltage which increases from the base potential (e.g. voltage 0 (V)) to voltage Vr2 as a first voltage is applied to scan electrodes SC1 through SCn.

Voltage Vr2 is set at the following voltage:
the voltage exceeds the discharge start voltage between scan electrode SCi and sustain electrode SUi and the discharge start voltage between scan electrode SCi and data electrode Dk in the discharge cell having undergone address discharge; and
the voltage does not cause discharge in the discharge having undergone no address discharge.

In the present exemplary embodiment, voltage Vr2 is set higher than voltage Vr1 described later.

In the discharge cell having undergone address discharge in immediately preceding address period Tw1, while the first up-ramp waveform voltage is applied to scan electrodes SC1 through SCn, feeble discharge (erasing discharge) continuously occurs between sustain electrode SUi and scan electrode SCi, and feeble discharge continuously occurs between scan electrode SCi and data electrode Dk.

Then, ultraviolet rays generated by the feeble discharge cause phosphor layer 35 of this discharge cell to emit light. At this time, discharge caused by the first up-ramp waveform voltage becomes feebler than discharge caused by the sustain pulse, so that the light emission by the feebler discharge has a luminance lower than that of the light emission by the sustain pulse.

Thus, in sustain period Ts1 of subfield SF1 as a weak-discharge sustain operation subfield, strong light emission by the sustain pulse does not occur and feeble light emission occurs by the first up-ramp waveform voltage. Thus, in subfield SF1, a gradation darker than that in the subfield to perform a strong-discharge sustain operation can be displayed on panel 10.

Charged particles generated by the feeble discharge are accumulated as wall charge on sustain electrode SUi and scan electrode SCi so as to reduce the voltage difference between sustain electrode SUi and scan electrode SCi. Thus, the wall voltage on scan electrode SCi and the wall voltage on sustain electrode SUi are reduced.

Since feeble discharge occurs between scan electrode SCi and data electrode Dk, positive wall voltage is accumulated on data electrode Dk.

In the discharge cell having undergone no address discharge in immediately preceding address period Tw1, discharge does not occur and the wall voltage at the completion of initializing period Ti1 is kept.

After the first up-ramp waveform voltage arrives at voltage Vr2, the voltage applied to scan electrodes SC1 through SCn is decreased to voltage 0 (V).

The next driving voltage waveform applied to scan electrode 22 differs between a discharge cell where a selective initializing operation is performed and a discharge cell where a forced initializing operation is performed, in initializing period Ti2 of subsequent subfield SF2.

A second up-ramp waveform voltage which gently increases from the base potential (e.g. voltage 0 (V)) to voltage Vr3 as a second voltage is applied to scan electrode 22 (scan electrode SC2 in the example of FIG. 3) of the discharge cell where a selective initializing operation is performed in initializing period Ti2 of subsequent subfield SF2.

Voltage Vr3 is set equal to voltage Vr2 or slightly lower than voltage Vr2.

Not the second up-ramp waveform voltage but a voltage (e.g. voltage 0 (V)) that does not cause discharge is applied to scan electrode 22 (scan electrode SC1 in the example of FIG. 3) of the discharge cell where a forced initializing operation is performed in initializing period Ti2 of subsequent subfield SF2.

A third up-ramp waveform voltage which starts to gently increase from voltage 0 (V) is applied to data electrodes D1 through Dm simultaneously with the time when the second up-ramp waveform voltage starts to increase, or after the voltage starts to increase and before the voltage arrives at voltage Vr3.

Specifically, simultaneously with the time when the second up-ramp waveform voltage starts to increase, or after the voltage starts to increase and before the voltage arrives at voltage Vr3, data electrodes D1 through Dm are put into a high impedance state.

By putting data electrodes D1 through Dm into the high impedance state, the voltage of data electrodes D1 through Dm gradually increases with increase of the second up-ramp waveform voltage. Thus, the third up-ramp waveform voltage is applied to data electrodes D1 through Dm.

The value to which the voltage of data electrodes D1 through Dm increases depends on the timing with which data electrodes D1 through Dm are put into the high impedance state. In the present exemplary embodiment, the timing with which data electrodes D1 through Dm are put into the high impedance state is set so that the third up-ramp waveform voltage arrives at voltage Vd before the second up-ramp waveform voltage arrives at voltage Vr3, for example.

In the discharge cell having undergone address discharge in address period Tw1 (namely, in the discharge cell where the first up-ramp waveform voltage has caused discharge), by applying the second up-ramp waveform voltage, feeble discharge (erasing discharge) continuously occurs again between scan electrode 22 (e.g. scan electrode SC2) and sustain electrode 23 (e.g. sustain electrode SU2).

Charged particles generated by the feeble discharge are accumulated as wall charge on sustain electrode SU2 and scan electrode SC2 so as to reduce the voltage difference between sustain electrode SU2 and scan electrode SC2. Thus, the positive wall voltage on scan electrode SC2 and the negative wall voltage on sustain electrode SU2 are certainly reduced.

Thus, in sustain period Ts1, the following operations are performed:
the first up-ramp waveform voltage and second up-ramp waveform voltage are sequentially applied to the discharge cell where a selective initializing operation is performed in initializing period Ti2 of subsequent subfield SF2; and
the first up-ramp waveform voltage and a voltage causing no discharge are sequentially applied to the discharge cell where a forced initializing operation is performed in initializing period Ti2 of subsequent subfield SF2.
   The reason for this is described later.

After the voltage applied to scan electrode SC2 arrives at voltage Vr3, the voltage applied to scan electrode SC2 is decreased to voltage 0 (V) in preparation for the subsequent initializing operation. Thus, sustain period Ts1 of subfield SF1 is completed.

Thus, subfield SF1 that is a weak-discharge sustain operation subfield and selective initializing subfield is completed.

Next, subfield SF2 that is a specific-cell initializing subfield and strong-discharge sustain operation subfield is described.

In the initializing period of the specific-cell initializing subfield, there are discharge cells that are to be subjected to a forced initializing operation and discharge cells that are to be subjected to a selective initializing operation.

Hereinafter, scan electrode SC1 and scan electrode SC2 are described as an example. Scan electrode SC1 is an example of scan electrode 22 included in the discharge cell where a forced initializing operation is performed in the initializing period of the specific-cell initializing subfield. A driving voltage waveform similar to that to scan electrode SC1 is applied to other scan electrodes 22 to undergo a similar forced initializing operation. Scan electrode SC2 is an example of scan electrode 22 included in the discharge cell where a selective initializing operation is performed in the initializing period of the specific-cell initializing subfield. A driving voltage waveform similar to that to scan electrode SC2 is applied to other scan electrodes 22 to undergo a similar selective initializing operation.

In the first half of initializing period Ti2 of subfield SF2, voltage 0 (V) is applied to sustain electrodes SU1 through SUn.

To scan electrode SC1 to undergo the forced initializing operation, voltage 0 (V) is applied, then voltage Vi1 is applied, and then a fourth up-ramp waveform voltage which gently increases from voltage Vi1 to voltage Vi2 is applied. Voltage Vi1 is set lower than the discharge start voltage with respect to sustain electrode SU1, and voltage Vi2 is set higher than the discharge start voltage.

A fifth up-ramp waveform voltage which starts to gently increase from voltage 0 (V) is applied to data electrodes D1 through Dm simultaneously with the time when the fourth up-ramp waveform voltage starts to increase, or after the voltage starts to increase and before the voltage arrives at voltage Vi2.

Specifically, simultaneously with the time when the fourth up-ramp waveform voltage starts to increase, or after the voltage starts to increase and before the voltage arrives at voltage Vi2, data electrodes D1 through Dm are put into a high impedance state.

By putting data electrodes D1 through Dm into the high impedance state, the voltage of data electrodes D1 through Dm gradually increases with increase of the fourth up-ramp waveform voltage. Thus, the fifth up-ramp waveform voltage is applied to data electrodes D1 through Dm.

The value to which the voltage of data electrodes D1 through Dm increases depends on the timing with which data electrodes D1 through Dm are put into the high impedance state. In the present exemplary embodiment, the timing with which data electrodes D1 through Dm are put into the high impedance state is set so that the fifth up-ramp waveform voltage arrives at voltage Vd before the fourth up-ramp waveform voltage arrives at voltage Vi2, for example.

While the fourth up-ramp waveform voltage is applied to scan electrode SC1, regardless of the presence or absence of the previous discharge, feeble initializing discharge continuously occurs between scan electrode SC1 and sustain electrode SU1 in each discharge cell, and feeble initializing discharge continuously occurs also between scan electrode SC1 and data electrodes D1 through Dm.

By this initializing discharge, negative wall voltage is accumulated on scan electrode SC1, and positive wall voltage is accumulated on data electrodes D1 through Dm and sustain electrode SU1. Furthermore, priming particles for supporting occurrence of address discharge are generated in the discharge cell.

In the present exemplary embodiment, the wall voltage accumulated on data electrodes D1 through Dm is adjusted by increasing the fifth up-ramp waveform voltage applied to data electrodes D1 through Dm to voltage Vd, for example.

After the fourth up-ramp waveform voltage arrives at voltage Vi2, the voltage applied to scan electrode SC1 is decreased to voltage 0 (V) in preparation for the latter half of initializing period Ti2.

While the fourth up-ramp waveform voltage is applied to scan electrode SC1 where a forced initializing operation is performed, a voltage (e.g. voltage 0 (V)) that does not cause discharge is applied to scan electrode SC2 where a selective initializing operation is performed. Therefore, in the discharge cell where the selective initializing operation is performed in initializing period Ti2, discharge does not occur in the first half of initializing period Ti2.

Thus, the first half of initializing period Ti2 is completed.

In the latter half of initializing period Ti2, voltage 0 (V) is applied to data electrodes D1 through Dm, and voltage Ve is applied to sustain electrodes SU1 through SUn.

To scan electrodes SC1 through SCn, a down-ramp waveform voltage is applied which gently decreases from voltage 0 (V) lower than the discharge start voltage to a negative voltage Vi4. Voltage Vi4 is set at a voltage that exceeds the discharge start voltage with respect to sustain electrodes SU1 through SUn.

In the discharge cell having undergone discharge in the first half of initializing period Ti2, while the down-ramp waveform voltage is applied to scan electrodes SC1 through SCn, feeble initializing discharge continuously occurs between scan electrode SC1 and sustain electrode SU1 and between scan electrode SC1 and data electrodes D1 through Dm, for example.

In the discharge cell that has undergone no initializing discharge in the first half of initializing period Ti2 and has undergone address discharge in address period Tw1 of immediately preceding subfield SF1, feeble initializing discharge continuously occurs between scan electrode SC2 and sustain electrode SU2 and between scan electrode SC2 and data electrodes D1 through Dm, for example.

In the discharge cell having undergone the feeble initializing discharge, the negative wall voltage on scan electrode 22 and the positive wall voltage on sustain electrode 23 are reduced, and the positive wall voltage on data electrode 32 is adjusted to a voltage appropriate for the address operation in the subsequent address period. Priming particles are generated in the discharge cell.

In the discharge cell that has undergone no initializing discharge in the first half of initializing period Ti2 and has undergone no address discharge in address period Tw1 of immediately preceding subfield SF1, initializing discharge does not occur either in the latter half of initializing period Ti2, and the wall voltage is kept as it is.

After the down-ramp waveform voltage arrives at voltage Vi4, the voltage applied to scan electrodes SC1 through SCn is set at voltage Vc in preparation for the subsequent address operation.

Thus, the initializing operation in initializing period Ti2 of subfield SF2 as a specific-cell initializing subfield is completed. In the initializing period (specific-cell initializing period), there are discharge cells to undergo a forced initializing operation and discharge cells to undergo a selective initializing operation. Here, in the forced initializing operation, the fourth up-ramp waveform voltage and the down-ramp waveform voltage are sequentially applied. In the selective initializing operation, the fourth up-ramp waveform voltage is not applied and the down-ramp waveform voltage is applied.

Hereinafter, a driving voltage waveform that is used for performing the forced initializing operation and is applied to scan electrode 22 of the discharge cell where the forced initializing operation is performed in the specific-cell initializing period is referred to as “forced initializing waveform”. A driving voltage waveform that is used for performing the selective initializing operation and is applied to scan electrode 22 of the discharge cell where the selective initializing operation is performed in the specific-cell initializing period is referred to as “selective initializing waveform”.

In address period Tw2 of subfield SF2, a driving voltage waveform for causing address discharge in a discharge cell to emit light is applied to each electrode similarly in address period Tw1 of subfield SF1.

Next, sustain period Ts2 of subfield SF2 is described.

In sustain period Ts2 of subfield SF2 as a strong-discharge sustain operation subfield, voltage 0 (V) is applied to data electrodes D1 through Dm. Then, voltage 0 (V) is applied to sustain electrodes SU1 through SUn, and a sustain pulse of positive voltage Vs is applied to scan electrodes SC1 through SCn.

In the discharge cell where address discharge is caused in immediately preceding address period Tw2, by application of the sustain pulse, the voltage difference between scan electrode SCi and sustain electrode SUi exceeds the discharge start voltage, and strong discharge (sustain discharge) occurs between scan electrode SCi and sustain electrode SUi. Then, ultraviolet rays generated by the sustain discharge cause phosphor layer 35 of this discharge cell to emit light.

The discharge caused by the sustain pulse is stronger than the discharge caused by the first up-ramp waveform voltage, so that the light emission by the strong-discharge sustain operation has a luminance higher than that of the light emission by the weak-discharge sustain operation.

By this sustain discharge, negative wall voltage is accumulated on scan electrode SCi, and positive wall voltage is accumulated on sustain electrode SUi. Positive wall voltage is also accumulated on data electrodes Dk. However, sustain discharge does not occur in the discharge cell having undergone no address discharge in immediately preceding address period Tw2, and the wall voltage at the completion of initializing period Ti2 is kept.

Subsequently, voltage 0 (V) is applied to scan electrodes SC1 through SCn, and a sustain pulse of voltage Vs is applied to sustain electrodes SU1 through SUn. Sustain discharge occurs again in the discharge cell having undergone sustain discharge immediately before the application, and light is emitted in phosphor layer 35 of this discharge cell. Then, negative wall voltage is accumulated on sustain electrode SUi of the discharge cell, and positive wall voltage is accumulated on scan electrodes SCi.

Hereinafter, similarly, as many sustain pulses as the number derived by multiplying the luminance weight by a predetermined luminance magnification are alternately applied to scan electrodes SC1 through SCn and sustain electrodes SU1 through SUn. Thus, in the discharge cell having undergone address discharge in immediately preceding address period Tw2, as many sustain discharges as the number corresponding to the luminance weight of subfield SF2 occur, and light is emitted at a luminance corresponding to the luminance weight.

After generation of the sustain pulses (after the completion of the sustain operation in the sustain period), a sixth up-ramp waveform voltage is applied to scan electrodes SC1 through SCn while voltage 0 (V) is applied to sustain electrodes SU1 through SUn and data electrodes D1 through Dm. Here, the sixth up-ramp waveform voltage gently increases from the base potential (e.g. voltage 0 (V)) to voltage Vr1 as the third voltage. Voltage Vr1 is set higher than the discharge start voltage.

While the sixth up-ramp waveform voltage is applied to scan electrodes SC1 through SCn, feeble discharge (erasing discharge) continuously occurs in the discharge cell having undergone sustain discharge.

Thus, the wall voltage on scan electrode SCi and the wall voltage on sustain electrode SUi are reduced while the positive wall voltage is kept on data electrode Dk. Thus, unnecessary wall charge in the discharge cell is erased.

After the sixth up-ramp waveform voltage arrives at voltage Vr1, the voltage applied to scan electrodes SC1 through SCn is set at voltage 0 (V) in preparation for the subsequent initializing operation. Thus, the erasing operation is completed, and sustain period Ts2 of subfield SF2 is completed.

Thus, subfield SF2 that is a strong-discharge sustain operation subfield and specific-cell initializing subfield is completed.

Thus, in sustain period Ts2 of subfield SF2 as the strong-discharge sustain operation subfield, strong light emission is caused by the sustain pulses. Thus, in subfield SF2, a gradation brighter than that in the subfield to perform the weak-discharge sustain operation can be displayed on panel 10.

Next, subfield SF3 that is a selective initializing subfield and strong-discharge sustain operation subfield is described.

In initializing period Ti3 of subfield SF3 where a selective initializing operation is performed, a driving voltage similar to that in initializing period Ti1 of subfield SF1 is applied to each electrode, and a selective initializing operation similar to that in subfield SF1 is performed. In other words, voltage 0 (V) is applied to data electrodes D1 through Dm, voltage Ve is applied to sustain electrodes SU1 through SUn, and a down-ramp waveform voltage which decreases from voltage 0 (V) to voltage Vi4 is applied to scan electrodes SC1 through SCn. Thus, initializing discharge is caused in the discharge cell having undergone sustain discharge in the immediately preceding sustain period (sustain period Ts2 of subfield SF2 here).

In address period Tw3 of subfield SF3, a driving voltage waveform for causing address discharge in a discharge cell to emit light is applied to each electrode similarly in address period Tw2 of subfield SF2.

In sustain period Ts3 of subfield SF3 that is a strong-discharge sustain operation subfield, a driving voltage similar to that in sustain period Ts2 of subfield SF2 is applied to each electrode except for the number of generated sustain pulses, and a sustain operation similar to that in subfield SF2 is performed. In other words, as many sustain pulses as the number corresponding to the luminance weight of subfield SF3 are alternately applied to scan electrodes SC1 through SCn and sustain electrodes SU1 through SUn, as many sustain discharges as the number corresponding to the luminance weight are caused in the discharge cell having undergone address discharge in immediately preceding address period Tw3, and light is emitted in the discharge cell at a luminance corresponding to the luminance weight.

After generation of the sustain pulses (after the completion of the sustain operation in sustain period Ts3), the sixth up-ramp waveform voltage is applied to scan electrodes SC1 through SCn while voltage 0 (V) is applied to sustain electrodes SU1 through SUn and data electrodes D1 through Dm. Thus, feeble erasing discharge is caused in the discharge cell having undergone sustain discharge.

Thus, subfield SF3 that is a strong-discharge sustain operation subfield and selective initializing subfield is completed.

Each of subfield SF4 and later is a strong-discharge sustain operation subfield and selective initializing subfield, similarly to subfield SF3. Therefore, in each of subfield SF4 and later, a driving voltage waveform similar to that in subfield SF3 is applied to each electrode except for the number of sustain pulses generated in the sustain period.

The driving voltage waveform in each of subfields included in one field has been described schematically.

In the present exemplary embodiment, data electrodes D1 through Dm are put into a high impedance state when the third up-ramp waveform voltage and fifth up-ramp waveform voltage are applied to data electrodes D1 through Dm. This operation is performed to simplify the data electrode driver circuit as much as possible, and is described later in detail.

The present invention is not limited to this configuration. For example, the following configuration may be employed:
the data electrode driver circuit includes a circuit for generating the third up-ramp waveform voltage and fifth up-ramp waveform voltage, and a driving voltage generated by the circuit is applied to data electrodes D1 through Dm with an appropriate timing.

In the present exemplary embodiment, the third up-ramp waveform voltage and fifth up-ramp waveform voltage are increased to voltage Vd. However, the present invention is not limited to this configuration. Preferably, the value to which the third up-ramp waveform voltage and fifth up-ramp waveform voltage are increased is set appropriately in response to the characteristics of panel 10, the configuration of the driver circuits, and the specification of the plasma display apparatus.

In the present exemplary embodiment, the following voltage values are applied to respective electrodes, for example. Voltage Vi1 is 150 (V), voltage Vi2 is 360 (V), voltage Vi4 is −180 (V), voltage Vc is −50 (V), voltage Va is −200 (V), voltage Vs is 210 (V), voltage Vr1 is 210 (V), voltage Vr2 is 270 (V), voltage Vr3 is 270 (V), voltage Ve is 150 (V), and voltage Vd is 60 (V).

The gradients of the first up-ramp waveform voltage, second up-ramp waveform voltage, and fourth up-ramp waveform voltage are approximately 1.3 (V/μsec), and the gradient of the sixth up-ramp waveform voltage is approximately 5 (V/μsec). The gradient of the down-ramp waveform voltage in the initializing period is approximately −2.5 (V/μsec).

In the present exemplary embodiment, however, the specific numerical values such as the voltage values and gradients are simply one example. In the present invention, the voltage values and gradients are not limited to the above-mentioned numerical values. Preferably, the voltage values and gradients are set optimally based on the discharge characteristics of panel 10 and the specification of the plasma display apparatus.

In the present exemplary embodiment, in sustain period Ts1 of subfield SF1 that is a weak-discharge sustain operation subfield, voltage Vr3 of the second up-ramp waveform voltage is set equal to voltage Vr2 of the first up-ramp waveform voltage or slightly lower than voltage Vr2. Even by this setting, feeble discharge can be caused again in the discharge cell to which the second up-ramp waveform voltage has been applied (the discharge cell where discharge has been caused by the first up-ramp waveform voltage). A reason for this is described below.

Hereinafter, scan electrode SC2 and sustain electrode SU2 are described as an example. Scan electrode SC2 and sustain electrode SU2 are examples of scan electrode 22 and sustain electrode 23 included in the discharge cell where a selective initializing operation is performed in the specific-cell initializing subfield (e.g. subfield SF2) immediately after a weak-discharge sustain operation subfield (e.g. subfield SF1). In the discharge cell used in the following description, address discharge is assumed to occur in address period Tw1.

Discharge between scan electrode SC2 and sustain electrode SU2 occurs after the voltage difference between scan electrode SC2 and sustain electrode SU2 exceeds the discharge start voltage. However, the discharge start voltage is not determined by the voltage difference between scan electrode SC2 and sustain electrode SU2 alone. The discharge start voltage depends on the potential gradient (spatial variation of electric field) near the electrode that serves as the negative electrode side for emitting electrons.

For example, when scan electrode SC2 is an electrode on the positive electrode side and sustain electrode SU2 is an electrode on the negative electrode side, the discharge start voltage between scan electrode SC2 and sustain electrode SU2 depends on the potential gradient near sustain electrode SU2 on the negative electrode side for emitting electrons.

Specifically, when the potential gradient near sustain electrode SU2 is relatively gentle (spatial variation of electric field is relatively small), the discharge start voltage between scan electrode SC2 and sustain electrode SU2 relatively increases and discharge occurs relatively hardly.

Conversely, when the potential gradient near sustain electrode SU2 is relatively steep (spatial variation of electric field is relatively large), the discharge start voltage between scan electrode SC2 and sustain electrode SU2 relatively decreases and discharge is relatively apt to occur.

The potential gradients near scan electrode SC2 and near sustain electrode SU2 depend on the voltage of data electrode Dj crossing scan electrode SC2 and sustain electrode SU2.

For example, when the absolute value of the potential difference between scan electrode SC2 and data electrode Dj is larger than the absolute value of the potential difference between sustain electrode SU2 and data electrode Dj, the potential gradient near scan electrode SC2 is steeper than that near sustain electrode SU2.

Conversely, when the absolute value of the potential difference between sustain electrode SU2 and data electrode Dj is larger than the absolute value of the potential difference between scan electrode SC2 and data electrode Dj, the potential gradient near sustain electrode SU2 is steeper than that near scan electrode SC2.

Therefore, in order to cause discharge between scan electrode SC2 and sustain electrode SU2 while scan electrode SC2 is set as an electrode on the positive electrode side and sustain electrode SU2 is set as an electrode on the negative electrode side, the voltage on data electrode Dj is made relatively high. Thus, the potential gradient near scan electrode SC2 on the positive electrode side becomes relatively gentle and the potential gradient near sustain electrode SU2 on the negative electrode side becomes relatively steep, so that the discharge start voltage relatively decreases and discharge is relatively apt to occur.

In the present exemplary embodiment, when the second up-ramp waveform voltage is applied to scan electrode SC2, the third up-ramp waveform voltage is applied to data electrodes D1 through Dm. Thus, the potential gradient near scan electrode SC2 on the positive electrode side is made relatively gentle and the potential gradient near sustain electrode SU2 on the negative electrode side for emitting electrons is made relatively steep. Therefore, the discharge start voltage between scan electrode SC2 and sustain electrode SU2 can be relatively decreased, and occurrence of discharge can be relatively facilitated.

For the above-mentioned reason, even if voltage Vr3 of the second up-ramp waveform voltage is set equal to voltage Vr2 of the first up-ramp waveform voltage or slightly lower than voltage Vr2, feeble discharge can be caused again between scan electrode SC2 and sustain electrode SU2 in the discharge cell to which the second up-ramp waveform voltage has been applied. Here, this discharge cell has undergone discharge by the first up-ramp waveform voltage.

Preferably, based on the above-mentioned descriptions, the value to which the third up-ramp waveform voltage is increased is set so that discharge is appropriately caused by the second up-ramp waveform voltage.

Next, the reason for performing the following operation is described:
in a sustain period (e.g. sustain period Ts1) to perform a weak-discharge sustain operation, the first up-ramp waveform voltage and second up-ramp waveform voltage are sequentially applied to scan electrode 22 (e.g. scan electrode SC2) of the discharge cell where a selective initializing operation is performed in the initializing period (e.g. initializing period Ti2) of the subsequent subfield.

In the present exemplary embodiment, in initializing period Ti2 of subfield SF2, there are discharge cells to undergo a forced initializing operation and discharge cells to undergo a selective initializing operation. In other words, there are discharge cells where a weak-discharge sustain operation is performed in sustain period Ts1 of subfield SF1 and a forced initializing operation is performed in initializing period Ti2 of subfield SF2, and discharge cells where a weak-discharge sustain operation is performed in sustain period Ts1 of subfield SF1 and a selective initializing operation is performed in initializing period Ti2 of subfield SF2.

Therefore, if a gradation for causing light emission only in subfield SF1 that is a weak-discharge sustain operation subfield is continuously displayed on panel 10, the following two kinds of discharge cells are generated:
discharge cells where a weak-discharge sustain operation is performed, then a forced initializing operation is performed, and then a weak-discharge sustain operation is performed again; and
discharge cells where a weak-discharge sustain operation is performed, then a selective initializing operation is performed, and then a weak-discharge sustain operation is performed again.

When the gradation for causing light emission only in subfield SF1 is displayed on panel 10, the discharge related to image display is address discharge occurring in address period Tw1 of subfield SF1 and erasing discharge occurring in sustain period Ts1.

When address discharge occurs, light emission is caused by this discharge in the discharge cell. The sustain discharge caused by a sustain pulse is strong, so that the light emission caused by address discharge has a luminance lower than that of the light emission caused by sustain discharge. While, the light emission caused by address discharge has a luminance lower than that of the light emission caused by erasing discharge that is caused by the first up-ramp waveform voltage.

In the sustain period of subfield SF1 that is a weak-discharge sustain operation subfield, strong discharge by a sustain pulse does not occur, and weak discharge (erasing discharge) by the first up-ramp waveform voltage occurs. Therefore, when the gradation for causing light emission only in subfield SF1 is displayed on panel 10, the intensity of the light emission caused by address discharge of subfield SF1 affects the luminance of the gradation displayed on panel 10.

Therefore, if the luminance of the light emission caused by address discharge differs between discharge cells, light emission luminance can differ between discharge cells when the gradation for causing light emission only in subfield SF1 is displayed on panel 10, for example.

The luminance of the light emission caused by address discharge varies in response to the discharge intensity of the address discharge. The discharge intensity of the address discharge varies in response to the presence or absence of the forced initializing operation in the initializing period before the address period.

In the discharge cell where a forced initializing operation is performed in the initializing period of a specific-cell initializing subfield, the wall voltage on scan electrode 22 and the wall voltage on sustain electrode 23 are adjusted relatively accurately. Therefore, the difference in discharge intensity of the address discharge between the discharge cells having undergone the forced initializing operation is relatively small.

While, in the discharge cell to undergo a selective initializing operation in the initializing period of a specific-cell initializing subfield, the accuracy of the adjustment of the wall voltage on scan electrode 22 and the wall voltage on sustain electrode 23 is lower than that in the discharge cell having undergone a forced initializing operation. Therefore, between the discharge cell having undergone the forced initializing operation and the discharge cell having undergone the selective initializing operation, the discharge intensity of the subsequent address discharge is apt to differ. The discharge intensity of address discharge can differ between the discharge cells having undergone the selective initializing operation.

For example, when either of the positive wall voltage on scan electrode 22 and the negative wall voltage on sustain electrode 23 that have been generated in the subfield immediately before a specific-cell initializing subfield is kept without being sufficiently adjusted in the initializing period of the specific-cell initializing subfield, the discharge intensity of the address discharge caused in the subsequent address operation decreases, and the luminance of the light emission caused by the address discharge can decrease relatively.

In order to reduce the variation of the discharge intensity of the address discharge between the discharge cell to undergo a forced initializing operation in the initializing period of the specific-cell initializing subfield and the discharge cell to undergo a selective initializing operation therein, and in order to equalize the intensities of the light emission caused by the address discharge between the discharge cells, voltage Vr2 of the first up-ramp waveform voltage is set at a further high voltage in sustain period Ts1 of immediately preceding subfield SF1, for example.

Thus, the duration of the erasing discharge caused by the first up-ramp waveform voltage between scan electrode 22 and sustain electrode 23 is increased relatively. The positive wall voltage on scan electrode SC2 and the negative wall voltage on sustain electrode 23 are more certainly reduced than when voltage Vr2 is set at a relatively low voltage.

Therefore, either of the positive wall voltage on scan electrode 22 and the negative wall voltage on sustain electrode 23 that have been generated in the subfield immediately before the specific-cell initializing subfield can be sufficiently adjusted even in the discharge cell to undergo a selective initializing operation in the initializing period of the specific-cell initializing subfield. Therefore, the discharge intensity of the address discharge caused by the subsequent address operation can be relatively increased. In other words, variation of the discharge intensity of the address discharge between the discharge cells can be reduced, and the intensities of the light emission caused by address discharge can be equalized between the discharge cells.

When voltage Vr2 is extremely increased, however, discharge by the first up-ramp waveform voltage can occur in the discharge cell having undergone no address discharge in address period Tw1 of subfield SF1.

In the present exemplary embodiment, voltage Vr2 is set so that discharge does not occur in the discharge cell having undergone no address discharge in address period Tw1 of subfield SF1. Insufficient erasing of wall charge in the discharge by the first up-ramp waveform voltage is compensated for by discharge by the second up-ramp waveform voltage.

In other words, in sustain period Ts1 of subfield SF1, the first up-ramp waveform voltage, which increases from voltage 0 (V) to voltage Vr2, is firstly applied to scan electrodes SC1 through SCn, and feeble discharge is caused between scan electrode SCi and sustain electrode SUi.

Voltage Vr2 is set so that appropriate positive wall voltage is accumulated on data electrode 32 of the discharge cell that has undergone address discharge in address period Tw1 of subfield SF1 and discharge does not occur in the discharge cell that has undergone no address discharge.

Next, the second up-ramp waveform voltage, which increases from voltage 0 (V) to voltage Vr3, is applied to scan electrode 22 (e.g. scan electrode SC2) where a selective initializing operation is performed in initializing period Ti2 of subsequent subfield SF2. The third up-ramp waveform voltage is applied to data electrodes D1 through Dm.

Voltage Vr3 is set equal to voltage Vr2 or slightly lower than voltage Vr2. Thus, unnecessary discharge is prevented from occurring in the discharge cell that has undergone no address discharge in address period Tw1 of subfield SF1. Then, as discussed above, by applying the third up-ramp waveform voltage to data electrodes D1 through Dm, erasing discharge occurs again in the discharge cell and the wall charge is further erased even if voltage Vr3 is not higher than voltage Vr2.

Thus, in the present exemplary embodiment, in the sustain period (e.g. sustain period Ts1) to perform a weak-discharge sustain operation, erasing discharge by the first up-ramp waveform voltage and erasing discharge by the second up-ramp waveform voltage are sequentially caused in the discharge cell where a selective initializing operation is performed in the initializing period (e.g. initializing period Ti2) of the subsequent subfield. Thus, the positive wall voltage on scan electrode 22 (e.g. scan electrode SC2) and the negative wall voltage on sustain electrode 23 (e.g. sustain electrode SU2) are certainly reduced. Variation in discharge intensity of the address discharge between the discharge cells can be reduced, and the intensities of the light emission caused by address discharge can be equalized between the discharge cells.

In the present exemplary embodiment, in the sustain period (e.g. sustain period Ts1) to perform a weak-discharge sustain operation, to scan electrode 22 (e.g. scan electrode SC1) where a strong-discharge sustain operation is performed in the initializing period (e.g. initializing period Ti2) of the subsequent subfield, the first up-ramp waveform voltage is applied, and then voltage (e.g. voltage 0 (V)) that does not cause discharge is applied. A reason for this is described below.

For example, when the gradation for causing light emission only in subfield SF1 that is a weak-discharge sustain operation subfield is continuously displayed on panel 10, the following four discharges sequentially occur in the discharge cell where a selective initializing operation is performed in the initializing period (e.g. initializing period Ti2) of the subsequent subfield:
address discharge occurring in the address period (e.g. address period Tw1) of the weak-discharge sustain operation subfield;
erasing discharge by the first up-ramp waveform voltage;
erasing discharge by the second up-ramp waveform voltage; and
initializing discharge by the down-ramp waveform voltage of the selective initializing operation.

In the same condition, in the discharge cell where a forced initializing operation is performed in the initializing period (e.g. initializing period Ti2) of the subsequent subfield, the following four discharges sequentially occur:
address discharge occurring in the address period (e.g. address period Tw1) of the weak-discharge sustain operation subfield;
erasing discharge by the first up-ramp waveform voltage;
initializing discharge by the fourth up-ramp waveform voltage of the forced initializing operation; and
initializing discharge by the down-ramp waveform voltage.

At this time, if the erasing discharge is caused by the second up-ramp waveform voltage in the discharge cell, five discharges sequentially occur in the discharge cell, and hence luminance difference can occur between this discharge cell and the discharge cell where a selective initializing operation is performed in the initializing period (e.g. initializing period Ti2) of the subsequent subfield.

This is a reason why the following operation is performed:
in a sustain period (e.g. sustain period Ts1) to perform a weak-discharge sustain operation, the first up-ramp waveform voltage and a voltage (e.g. voltage 0 (V)) that does not cause discharge are sequentially applied to scan electrode 22 (e.g. scan electrode SC1) of the discharge cell where a forced initializing operation is performed in the initializing period (e.g. initializing period Ti2) of the subsequent subfield.

Next, the relationship between scan electrode 22 and the field where a forced initializing operation is performed is described.

In the present exemplary embodiment, scan electrode 22 to which a forced initializing waveform is applied in a specific-cell initializing period is set based on the following rules. Scan electrode 22 to which a forced initializing waveform is applied in a specific-cell initializing period is hereinafter referred to as “specific scan electrode”.

When only one forced initializing operation is performed in one scan electrode 22 in one of N temporally continuous fields (N is an integer), N temporally continuous fields are set as one field group. Then, N consecutively arranged scan electrodes 22 are set as one scan electrode group.

The following rules are established under those conditions.

(Rule 1) In one scan electrode 22, the number of fields to perform a forced initializing operation is one in each field group. This translates into the following operation. To each scan electrode 22, a forced initializing waveform is applied only in a specific-cell initializing period in one field of each field group, and a selective initializing waveform is applied in specific-cell initializing periods in the other fields.

(Rule 2) The number of scan electrodes 22 where a forced initializing operation is performed in one field is one in each scan electrode group. This translates into the following operation. In a specific-cell initializing period in one field, a forced initializing waveform is applied to only one scan electrode 22 in each scan electrode group, and a selective initializing waveform is applied to other scan electrodes 22.

Rule 3 is established when N is five or more, namely when one field group is constituted by five or more fields.

(Rule 3) To scan electrode SCx−1 and scan electrode SCx+1 that are adjacent to scan electrode SCx to which a forced initializing waveform is applied in a specific-cell initializing period in one field, not a forced initializing waveform but a selective initializing waveform is applied in the specific-cell initializing period in at least the field and in the specific-cell initializing period in the next field.

Next, a generation pattern of a forced initializing operation based on the rules is described.

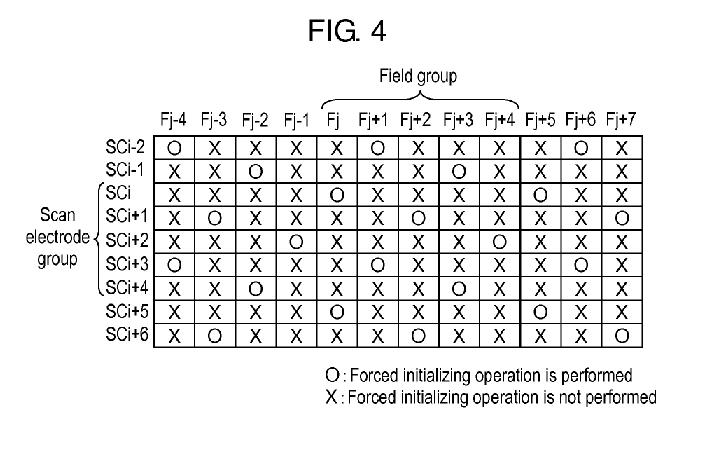

FIG. 4 is a diagram showing an example of a generation pattern of a forced initializing operation and a selective initializing operation in accordance with the first exemplary embodiment of the present invention. In FIG. 4, the horizontal axis shows fields, and the vertical axis shows scan electrodes 22.

FIG. 4 shows an example where N is five, five temporally continuous fields are set as one field group, and five consecutively arranged scan electrodes 22 are set as one scan electrode group. In the example of FIG. 4, one field group is constituted by field Fj, field Fj+1, field Fj+2, field Fj+3, and field Fj+4, and one scan electrode group is constituted by scan electrode SCi, scan electrode SCi+1, scan electrode SCi+2, scan electrode SCi+3, and scan electrode SCi+4.

In FIG. 4, “O” shows that a forced initializing operation is performed in initializing period Ti2 of subfield SF2 (namely, a forced initializing operation is performed in a specific-cell initializing period). “X” shows that no forced initializing operation is performed in initializing period Ti2 of subfield SF2 (namely, a selective initializing operation is performed in a specific-cell initializing period).

Therefore, in the example of FIG. 4, scan electrodes SCi and SCi+5 are specific scan electrodes 22 in field Fj, and scan electrodes SCi−2 and SCi+3 are specific scan electrodes 22 in field Fj+1. Thus, specific scan electrodes 22 are not fixed, but depend on the field.

As shown in FIG. 4, in the present exemplary embodiment, the number of fields to perform a forced initializing operation is one in each field group in one scan electrode 22 (Rule 1).

Thus, the number of forced initializing operations is decreased to ⅕ of that in the case where the forced initializing operation is performed in all discharge cells in each field. Therefore, the number of light emissions caused by the forced initializing operation is also decreased to ⅕. Thus, the number of light emissions that increase the luminance of black level can be minimized, thereby reducing the luminance of black level. The contrast ratio of the display image can be therefore increased.

In the present exemplary embodiment, the number of scan electrodes 22 where a forced initializing operation is performed in one field is one in each scan electrode group (Rule 2).

Thus, scan electrodes 22 to undergo a forced initializing operation are dispersed to respective fields. Therefore, flicker (screen seems to fluctuate) can be reduced comparing with the case where scan electrodes 22 to undergo a forced initializing operation are collected to one field.

“Scan electrodes 22 to undergo a forced initializing operation are collected to one field” means the following case, for example:
in each specific-cell initializing period, a forced initializing operation is performed in all scan electrodes 22 in one field of a field group, and a selective initializing operation is performed in all scan electrodes 22 in the other fields.

In the present exemplary embodiment, scan electrode SCx is assumed to be a scan electrode (e.g. scan electrode SCi) to which a forced initializing waveform is applied in the specific-cell initializing period in one field (e.g. field Fj). In this case, to scan electrode SCx−1 (e.g. scan electrode SCi−1) and scan electrode SCx+1 (e.g. scan electrode SCi+1) that are adjacent to scan electrode SCx, not a forced initializing waveform but a selective initializing waveform is applied in the specific-cell initializing period in at least the field (e.g. field Fj) and in the specific-cell initializing period in the next field (e.g. field Fj+1) (Rule 3).

Temporal and spatial continuity of the discharge cells to undergo a forced initializing operation is thus reduced, so that light emission by the forced initializing operation is difficult to be recognized by users.

Next, the configuration of the plasma display apparatus of the present exemplary embodiment is described.

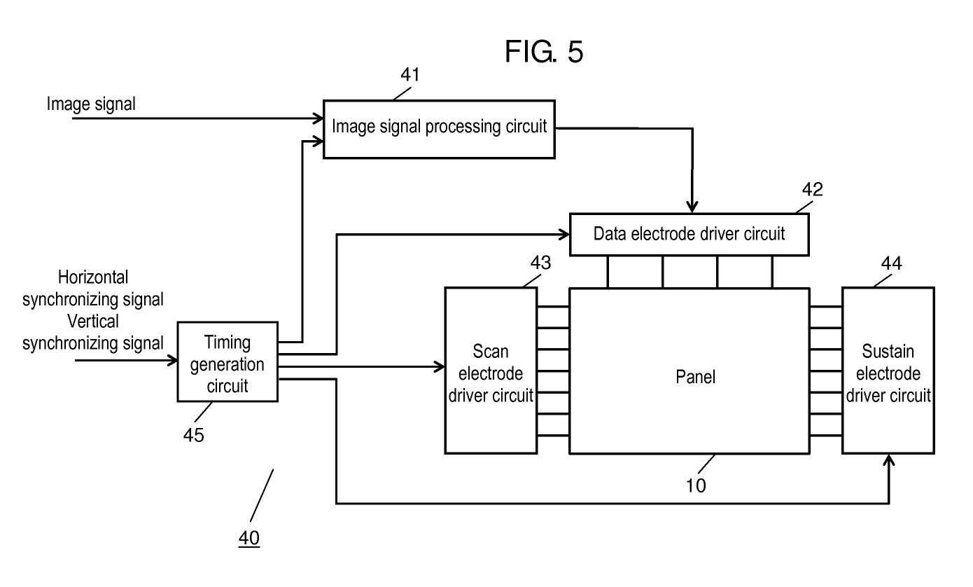

FIG. 5 is a diagram for schematically showing an example of circuit blocks constituting plasma display apparatus 40 in accordance with the first exemplary embodiment of the present invention.

Plasma display apparatus 40 includes panel 10 and a driver circuit for driving panel 10. The driver circuit includes the following elements:
image signal processing circuit 41;
data electrode driver circuit 42;
scan electrode driver circuit 43;
sustain electrode driver circuit 44;
timing generation circuit 45; and
a power supply circuit (not shown) for supplying power required for each circuit block.

Image signal processing circuit 41 receives an image signal and a timing signal supplied from timing generation circuit 45. Image signal processing circuit 41, in order to display an image based on the image signal on panel 10, assigns gradation values of red, green, and blue (gradation values represented in one field) to each discharge cell based on the image signal. Image signal processing circuit 41 converts the gradation values of red, green, and blue assigned to each discharge cell into image data that indicates lighting or no lighting in each subfield (light emission or no light emission corresponds to digital signal “1” or “0”), and outputs the image data (red image data, green image data, and blue image data).

Timing generation circuit 45 generates various timing signals for controlling the operations of respective circuit blocks based on a horizontal synchronizing signal and vertical synchronizing signal. Timing generation circuit 45 supplies the generated timing signals to respective circuit blocks (data electrode driver circuit 42, scan electrode driver circuit 43, sustain electrode driver circuit 44, and image signal processing circuit 41).

Data electrode driver circuit 42 generates address pulses of voltage Vd corresponding to data electrodes D1 through Dm based on the image data output from image signal processing circuit 41 and the timing signal supplied from timing generation circuit 45. Then, data electrode driver circuit 42 applies the address pulses to data electrodes D1 through Dm in the address period.

Scan electrode driver circuit 43 includes a ramp waveform voltage generation circuit, a sustain pulse generation circuit, and a scan pulse generation circuit (not shown in FIG. 5). Scan electrode driver circuit 43 generates driving voltage waveforms based on the timing signal supplied from timing generation circuit 45, and applies them to scan electrodes SC1 through SCn, respectively. The ramp waveform voltage generation circuit generates, based on the timing signal, a ramp waveform voltage to be applied to scan electrodes SC1 through SCn in the initializing period and sustain period. The sustain pulse generation circuit generates, based on the timing signal, sustain pulses to be applied to scan electrodes SC1 through SCn in the sustain period. The scan pulse generation circuit includes a plurality of scan electrode driver integrated circuits (scan ICs), and generates, based on the timing signal, scan pulses to be applied to scan electrodes SC1 through SCn in the address period.

Sustain electrode driver circuit 44 includes a sustain pulse generation circuit and a circuit (not shown in FIG. 5) for generating voltage Ve. Sustain electrode driver circuit 44 generates driving voltage waveforms based on the timing signal supplied from timing generation circuit 45, and applies them to sustain electrodes SU1 through SUn, respectively. Sustain electrode driver circuit 44 generates sustain pulses of voltage Vs and applies them to sustain electrodes SU1 through SUn in the sustain period. Sustain electrode driver circuit 44 applies voltage Ve to sustain electrodes SU1 through SUn in the selective initializing period, the latter half of the forced initializing period, and the address period.

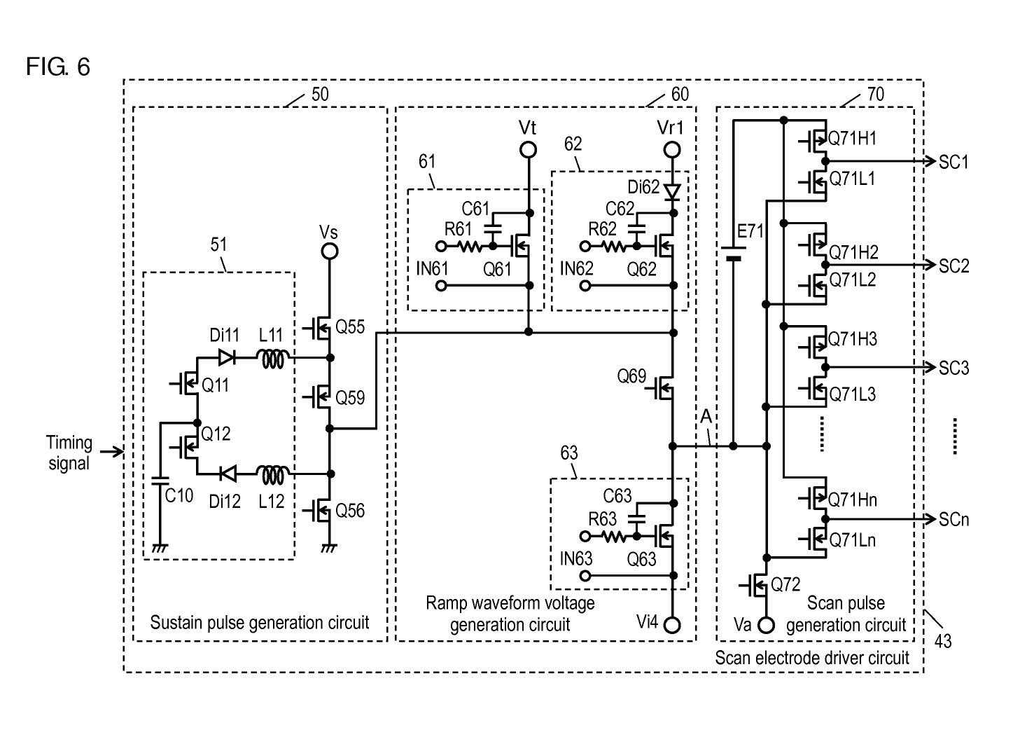

FIG. 6 is a circuit diagram for schematically showing a configuration example of scan electrode driver circuit 43 of plasma display apparatus 40 in accordance with the first exemplary embodiment of the present invention.

Scan electrode driver circuit 43 includes sustain pulse generation circuit 50, ramp waveform voltage generation circuit 60, and scan pulse generation circuit 70. Each circuit block works based on the timing signal supplied from timing generation circuit 45, but the details of the path of the timing signal are omitted in FIG. 6. The voltage input to scan pulse generation circuit 70 is denoted as “reference potential A”.

Sustain pulse generation circuit 50 includes power recovery circuit 51, switching element Q55, switching element Q56, and switching element Q59. Power recovery circuit 51 includes capacitor C10 for power recovery, switching element Q11, switching element Q12, diode Di11 and diode Di12 for back flow prevention, and inductor L11 and inductor L12 for resonance.

Power recovery circuit 51 recovers, from panel 10, the electric power accumulated in panel 10 by LC resonance of the inter-electrode capacity of panel 10 and inductor L12, and accumulates it in capacitor C10. Power recovery circuit 51 supplies the recovered electric power from capacitor C10 to panel 10 again by LC resonance of the inter-electrode capacity of panel 10 and inductor L11, and reuses it as electric power for driving scan electrodes SC1 through SCn.

Switching element Q55 clamps scan electrodes SC1 through SCn on voltage Vs, and switching element Q56 clamps scan electrodes SC1 through SCn on voltage 0 (V). Switching element Q59 is a separation switch and prevents current from flowing back via a parasitic diode or the like of a switching element constituting scan electrode driver circuit 43.

Sustain pulse generation circuit 50 thus generates sustain pulses of voltage Vs to be applied to scan electrodes SC1 through SCn.

Scan pulse generation circuit 70 includes switching elements Q71H1 through Q71Hn, switching elements Q71L1 through Q71Ln, switching element Q72, a power supply for generating negative voltage Va, and power supply E71 for generating voltage Vp. Then, voltage Vc (=Va+Vp) is generated by adding voltage Vp to voltage Va, and voltage Va and voltage Vc are applied to scan electrodes SC1 through SCn while switching between voltage Va and voltage Vc is performed, thereby generating scan pulses. For example, when voltage Va is −200 (V) and voltage Vp is 150 (V), voltage Vc becomes −50 (V).

Scan pulse generation circuit 70 sequentially applies the scan pulses to scan electrodes SC1 through SCn with timings of FIG. 3. Scan pulse generation circuit 70 outputs the output voltage of sustain pulse generation circuit 50 when the sustain pulses are applied to scan electrodes SC1 through SCn. In other words, the voltage of reference potential A is output to scan electrodes SC1 through SCn.

Ramp waveform voltage generation circuit 60 includes Miller integrating circuit 61, Miller integrating circuit 62, and Miller integrating circuit 63, and generates the ramp waveform voltage of FIG. 3.

Miller integrating circuit 61 includes transistor Q61, capacitor C61, and resistor R61. Miller integrating circuit 61 generates an up-ramp waveform voltage which gently increases to voltage Vt by applying a fixed voltage to input terminal IN61 (applying a fixed voltage difference between two circles shown as input terminal IN61).

For example, when voltage Vt is set equal to voltage Vr2, Miller integrating circuit 61 generates an up-ramp waveform voltage which gently increases to voltage Vr2 (first up-ramp waveform voltage generated in the sustain period of a weak-discharge sustain operation subfield) by applying a fixed voltage to input terminal IN61. Miller integrating circuit 61 generates an up-ramp waveform voltage which increases to voltage Vr3 (second up-ramp waveform voltage generated in the sustain period of a weak-discharge sustain operation subfield), and stops the operation of itself at the time when the voltage increases to voltage Vr3. Here, voltage Vr3 is equal to voltage Vr2, or slightly lower than voltage Vr2.

Miller integrating circuit 62 includes transistor Q62, capacitor C62, resistor R62, and diode Di62 for back flow prevention. Miller integrating circuit 62 generates an up-ramp waveform voltage which gently increases to voltage Vr1 (sixth up-ramp waveform voltage generated in the sustain period of a strong-discharge sustain operation subfield) by applying a fixed voltage to input terminal IN62 (applying a fixed voltage difference between two circles shown as input terminal IN62).

In scan electrode driver circuit 43, voltage Vr1 and voltage Vp may be set so that voltage Vp is equal to voltage Vi1 and the voltage derived by adding voltage Vp to voltage Vr1 is equal to voltage Vi2.

In this configuration, before start of the operation of Miller integrating circuit 62, switching element Q72 and switching elements Q71L1 through Q71Ln are set at OFF, switching element Q56, switching element Q69, and switching elements Q71H1 through Q71Hn are set at ON, thereby applying voltage Vp (=Vi1) to scan electrodes SC1 through SCn.

Then, switching element Q56 is set at OFF to start the operation of Miller integrating circuit 62, thereby adding voltage Vp of power supply E71 to the up-ramp waveform voltage generated by Miller integrating circuit 62 and generating the fourth up-ramp waveform voltage for a forced initializing operation. Here, the fourth up-ramp waveform voltage increases from voltage Vi1 to voltage Vi2.

Voltage Vr1 is set lower than voltage Vt, but diode Di62 for back flow prevention prevents current from flowing back from Miller integrating circuit 61 to the power supply for generating voltage Vr1.

Miller integrating circuit 63 includes transistor Q63, capacitor C63, and resistor R63. Miller integrating circuit 63 generates a down-ramp waveform voltage which gently decreases to voltage Vi4 (down-ramp waveform voltage generated in the integrating period) by applying a fixed voltage to input terminal IN63 (applying a fixed voltage difference between two circles shown as input terminal IN63).

A switching element for applying the voltage of reference potential A directly to the high-voltage-side input terminals of switching elements Q71H1 through Q71Hn, not to the high voltage side of power supply E71, may be disposed in scan pulse generation circuit 70 (not shown in FIG. 6). A switching element for applying a ground potential (voltage 0 (V)) to the low-voltage-side input terminals of switching elements Q71L1 through Q71Ln, not to reference potential A, may be disposed in scan pulse generation circuit 70. By disposing these switching elements, scan electrode driver circuit 43 can perform the operation where the ground potential is applied to scan electrode SC1 while the second up-ramp waveform voltage is applied to scan electrode SC2, for example (as shown in FIG. 3). Alternatively, scan electrode driver circuit 43 can perform the operation where the ground potential is applied to scan electrode SC2 while the fourth up-ramp waveform voltage is applied to scan electrode SC1.

Switching element Q69 is a separation switch and prevents current from flowing back via parasitic diodes or the like of the switching elements constituting scan electrode driver circuit 43.

These switching elements and transistors can be formed using a generally known semiconductor device such as a metal oxide semiconductor field effect transistor (MOSFET) or an insulated gate bipolar transistor (IGBT). These switching elements and transistors are controlled in response to the timing signals that are generated by timing generation circuit 45 and correspond to the switching elements and transistors.

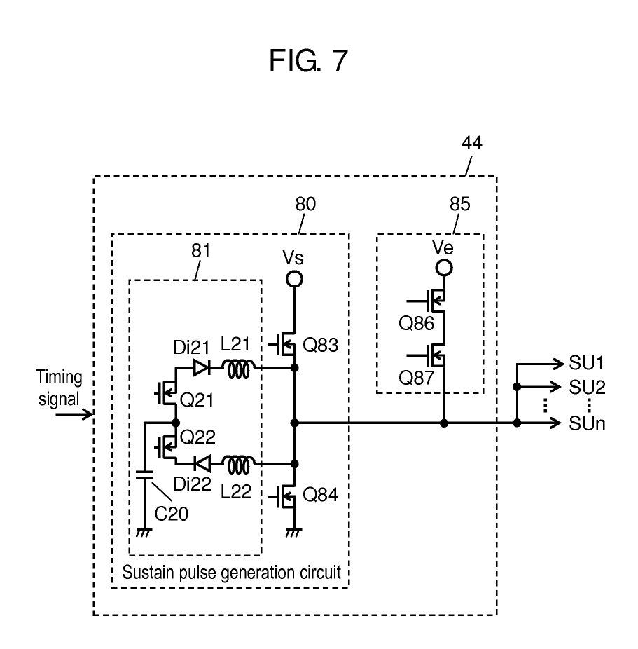

FIG. 7 is a circuit diagram for schematically showing a configuration example of sustain electrode driver circuit 44 of plasma display apparatus 40 in accordance with the first exemplary embodiment of the present invention.

Sustain electrode driver circuit 44 includes sustain pulse generation circuit 80 and fixed-voltage generation circuit 85. Each circuit block works based on the timing signal supplied from timing generation circuit 45, but the details of the path of the timing signal are omitted in FIG. 7.

Sustain pulse generation circuit 80 includes power recovery circuit 81, switching element Q83, and switching element Q84. Power recovery circuit 81 includes capacitor C20 for power recovery, switching element Q21, switching element Q22, diode Di21 and diode Di22 for back flow prevention, and inductor L21 and inductor L22 for resonance.

Power recovery circuit 81 recovers, from panel 10, the electric power accumulated in panel 10 by LC resonance of the inter-electrode capacity of panel 10 and inductor L22, and accumulates it in capacitor C20. Power recovery circuit 81 supplies the recovered electric power from capacitor C20 to panel 10 again by LC resonance of the inter-electrode capacity of panel 10 and inductor L21, and reuses it as electric power for driving sustain electrodes SU1 through SUn.

Switching element Q83 clamps sustain electrodes SU1 through SUn on voltage Vs, and switching element Q84 clamps sustain electrodes SU1 through SUn on voltage 0 (V).

Sustain pulse generation circuit 80 thus generates sustain pulses of voltage Vs to be applied to sustain electrodes SU1 through SUn.

Fixed-voltage generation circuit 85 includes switching element Q86 and switching element Q87. Fixed-voltage generation circuit 85 applies voltage Ve to sustain electrodes SU1 through SUn in the address period and the period in which the down-ramp waveform voltage is applied to scan electrodes SC1 through SCn in the initializing period.

These switching elements can be formed using a generally known semiconductor device such as MOSFET or IGBT. These switching elements are controlled in response to the timing signals that are generated by timing generation circuit 45 and correspond to the switching elements.

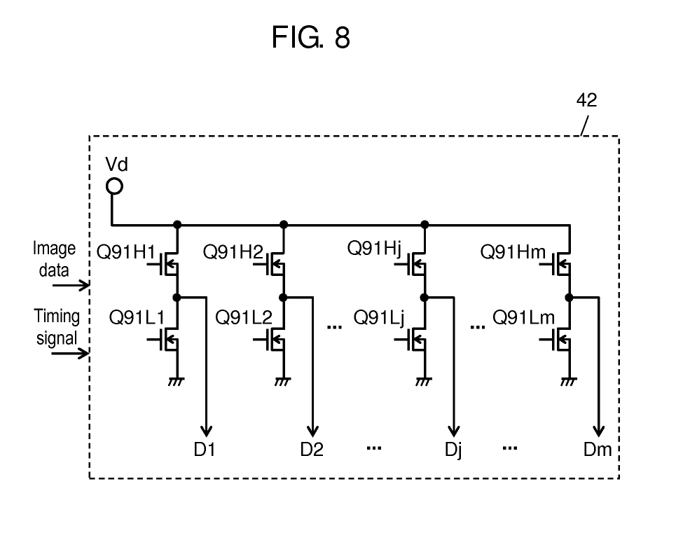

FIG. 8 is a circuit diagram for schematically showing a configuration example of data electrode driver circuit 42 of plasma display apparatus 40 in accordance with the first exemplary embodiment of the present invention.

Data electrode driver circuit 42 works based on the image data supplied from image signal processing circuit 41 and the timing signal supplied from timing generation circuit 45, but the details of the path of the timing signal are omitted in FIG. 8.

Data electrode driver circuit 42 includes switching elements Q91H1 through Q91Hm and switching elements Q91L1 through Q91Lm. Voltage 0 (V) is applied to data electrode Dj by setting switching element Q91Lj at ON, and voltage Vd is applied to data electrode Dj by setting switching element Q91Hj at ON.

Data electrode driver circuit 42 thus generates an address pulse of voltage Vd in the address period, and applies it to each of data electrodes D1 through Dm.

Data electrodes D1 through Dm can be put into the high impedance state, by simultaneously setting switching elements Q91H1 through Q91Hm and switching elements Q91L1 through Q91Lm at OFF. In the present exemplary embodiment, data electrodes D1 through Dm are kept in the high impedance state in the following periods:
the period in which the second up-ramp waveform voltage is applied to scan electrodes SC1 through SCn in the sustain period of the weak-discharge sustain operation subfield; and
the period in which the fourth up-ramp waveform voltage is applied to scan electrodes SC1 through SCn in the forced initializing period.

Thus, the voltage of data electrodes D1 through Dm can be increased in a ramp shape by using the up-ramp waveform voltage to be applied to scan electrodes SC1 through SCn via the inter-electrode capacity between data electrodes D1 through Dm and scan electrodes SC1 through SCn. In other words, the up-ramp waveform voltage can be applied to data electrodes D1 through Dm without disposing a ramp waveform voltage generation circuit such as a Miller integrating circuit in data electrode driver circuit 42.

In the present exemplary embodiment, thus, in the sustain period of the subfield to perform a weak-discharge sustain operation, no sustain pulse is generated, and the first up-ramp waveform voltage is applied to scan electrodes SC1 through SCn in the state where voltage 0 (V) is applied to data electrodes D1 through Dm. Thus, light is emitted in a discharge cell at a gradation using light emission feebler than the light emission by sustain pulses, and a darker gradation can be displayed on panel 10.

In the discharge cell to undergo a selective initializing operation in the initializing period of a specific-cell initializing subfield, the first up-ramp waveform voltage and second up-ramp waveform voltage are sequentially applied to scan electrode 22 and the third up-ramp waveform voltage is applied to data electrodes D1 through Dm in the sustain period of the immediately preceding weak-discharge sustain operation subfield. Thus, variation in discharge intensity of the address discharge between the discharge cells can be reduced, and the intensities of the light emission caused by address discharge can be equalized between the discharge cells.

In the discharge cell to undergo a forced initializing operation in the initializing period of a specific-cell initializing subfield, the first up-ramp waveform voltage and a voltage (e.g. voltage 0 (V)) that does not cause discharge are sequentially applied to scan electrode 22 in the sustain period of the immediately preceding weak-discharge sustain operation subfield. Thus, variation of the emission luminance can be reduced, and the image display quality of the plasma display apparatus can be improved.

### Second Exemplary Embodiment

The second exemplary embodiment describes an example of driving voltage waveforms having an advantage substantially similar to that of the driving voltage waveforms shown in FIG. 3 in the first exemplary embodiment. In this example, however, the driving voltage waveforms to be applied to scan electrodes SC1 through SCn are slightly different from those of FIG. 3.

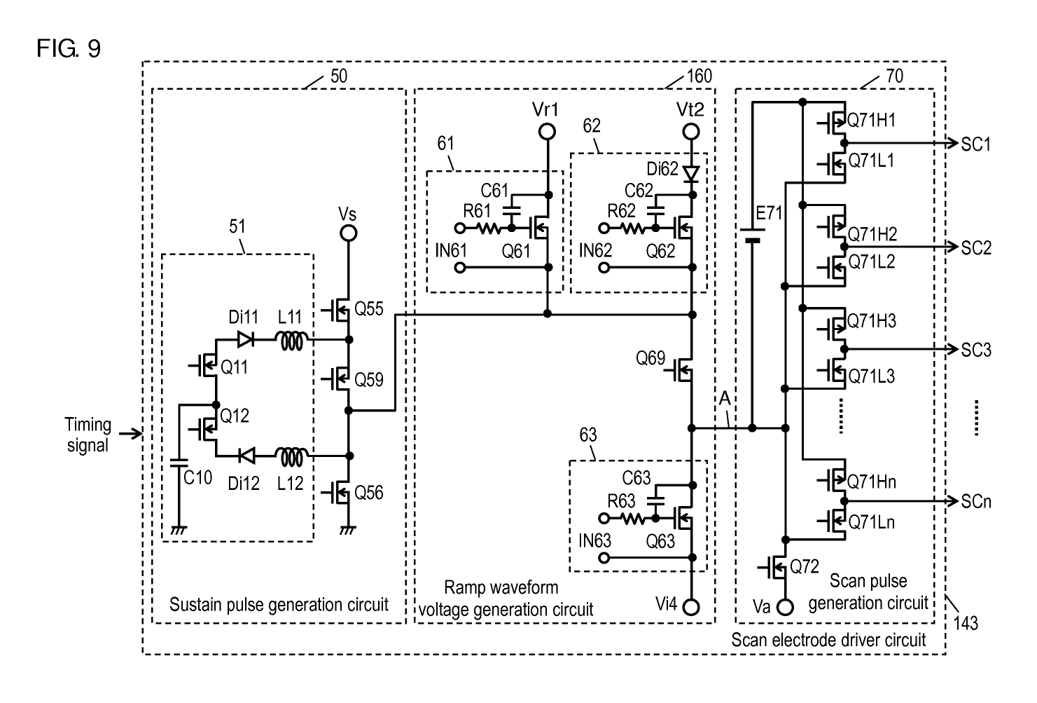

FIG. 9 is a circuit diagram for schematically showing a configuration example of scan electrode driver circuit 143 of a plasma display apparatus in accordance with a second exemplary embodiment of the present invention.

Scan electrode driver circuit 143 of FIG. 9 has substantially the same configuration as that of scan electrode driver circuit 43 shown in FIG. 6 of the first exemplary embodiment, and hence is not described in detail.

Scan electrode driver circuit 143 of FIG. 9 differs from scan electrode driver circuit 43 shown in FIG. 6 of the first exemplary embodiment in the following setting in ramp waveform voltage generation circuit 160:
the voltage of a power supply connected to Miller integrating circuit 61 is voltage Vr1;
the voltage of a power supply connected to Miller integrating circuit 62 is voltage Vt2; and
voltage Vt2 is lower than voltage Vr2 and voltage Vr1.

In scan electrode driver circuit 143 of FIG. 9, both voltage Vr1 and voltage Vt2 are lower than voltage Vr2. Therefore, the first up-ramp waveform voltage, which continuously increases from 0 (V) to voltage Vr2, cannot be generated.

When the voltage derived by adding voltage Vp to voltage Vt2 is equal to voltage Vr2 or higher than voltage Vr2, however, an up-ramp waveform voltage that is substantially the same as the first up-ramp waveform voltage, which increases from 0 (V) to voltage Vr2, can be generated by the operation of two steps.

An example where the up-ramp waveform voltage which increases from 0 (V) to voltage Vr2 is generated in two steps is described together with the operations of scan electrode driver circuit 143 and data electrode driver circuit 42.

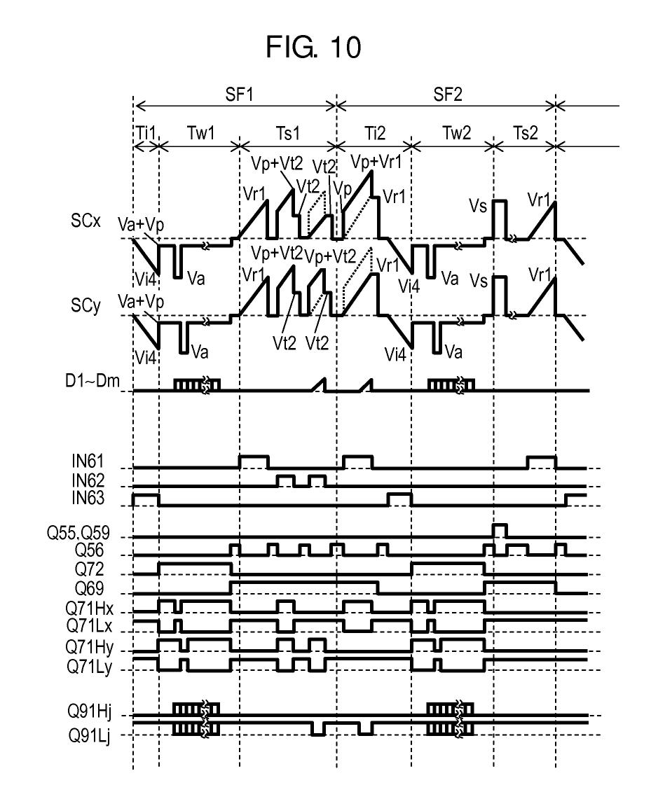

FIG. 10 is a timing chart showing an example of the operations of scan electrode driver circuit 143 and data electrode driver circuit 42 in accordance with the second exemplary embodiment of the present invention.

FIG. 10 shows driving voltage waveforms in subfield SF1 as a weak-discharge sustain operation subfield and subfield SF2 as a specific-cell initializing subfield, and the operations of scan electrode driver circuit 143 and data electrode driver circuit 42.

In FIG. 10, scan electrode SCx shows scan electrode 22 to which a forced initializing waveform is applied in initializing period Ti2, of scan electrodes SC1 through SCn, and scan electrode SCy shows scan electrode 22 to which a selective initializing waveform is applied.

In FIG. 10, switching element Q71Hx shows the switching element corresponding to scan electrode SCx, of switching elements Q71H1 through Q71Hn, and switching element Q71Hy shows the switching element corresponding to scan electrode SCy. Switching element Q71Lx shows the switching element corresponding to scan electrode SCx, of switching elements Q71L1 through Q71Ln, and switching element Q71Ly shows the switching element corresponding to scan electrode SCy.

The driving voltage waveform to be applied to sustain electrodes SU1 through SUn is substantially the same as that in FIG. 3, and hence is not described in FIG. 10.

In scan electrode driver circuit 143, voltage Vr3 is set equal to voltage Vr2. And voltage Vr1, voltage Vp, and voltage Vt2 are set so as to satisfy the following conditions:
voltage Vp is equal to voltage Vi1;
the voltage derived by adding voltage Vp to voltage Vr1 is equal to voltage Vi2; and
the voltage derived by adding voltage Vp to voltage Vt2 is equal to voltage Vr2.

In initializing period Ti1 of subfield SF1, switching elements Q81L1 through Q81Lm of data electrode driver circuit 42 are set at ON and switching elements Q81H1 through Q81Hm are set at OFF, thereby applying voltage 0 (V) to data electrodes D1 through Dm.

Switching element Q69 of scan electrode driver circuit 143 is set at OFF, switching elements Q71Hx and Q71Hy are set at OFF, and switching elements Q71Lx and Q71Ly are set at ON, thereby applying the voltage of reference potential A to scan electrodes SCx and SCy. Then, Miller integrating circuit 63 is operated by applying a fixed voltage to input terminal IN63 of Miller integrating circuit 63, and a down-ramp waveform voltage which gently decreases from voltage 0 (V) to voltage Vi4 is applied to scan electrodes SCx and SCy.

After the down-ramp waveform voltage arrives at voltage Vi4, transistor Q63 of Miller integrating circuit 63 is set at OFF (not shown), thereby stopping the operation of Miller integrating circuit 63.

In address period Tw1 of subfield SF1, the voltage of reference potential A is set at voltage Va by setting switching element Q72 at ON, and voltage Vc (=Va+Vp) is applied to scan electrodes SCx and SCy by setting switching elements Q71Lx and Q71Ly at OFF and switching elements Q71Hx and Q71Hy at ON.

Next, switching element Q71H1 is set at OFF and switching element Q71L1 is set at ON, thereby applying negative voltage Va to scan electrode SC1. Simultaneously, switching element Q81Lk for data electrode Dk corresponding to the discharge cell to emit light is set at OFF and switching element Q81Hk is set at ON, thereby applying voltage Vd to data electrode Dk.

After a certain time period (corresponding to the pulse width of a scan pulse), voltage Vc is applied to scan electrode SC1 by returning switching element Q71L1 to OFF and switching element Q71H1 to ON, and voltage 0 (V) is applied to data electrode Dk by returning switching element Q81Hk to OFF and switching element Q81Lk to ON.

Thus, a scan pulse is applied to scan electrode SC1, and an address pulse is applied to data electrode Dk corresponding to the discharge cell to emit light.

An operation similar to the above-mentioned one is performed in scan electrode SC2 through scan electrode SCn.

After the completion of the address operation in scan electrode SCn, switching elements Q72, Q71Hx, and Q71Hy are set at OFF, and switching elements Q56, Q69, Q71Lx, and Q71Ly are set at ON, thereby applying voltage 0 (V) to scan electrodes SCx and SCy.

In sustain period Ts1 of subfield SF1, an up-ramp waveform voltage which increases from voltage 0 (V) to voltage Vr1 is generated, and then an up-ramp waveform voltage which increases from voltage Vp to voltage Vp+Vt2 (=Vr2) is generated by adding voltage Vp to an up-ramp waveform voltage which increases from voltage 0 (V) to voltage Vt2. Thus, an up-ramp waveform voltage that is substantially the same as the first up-ramp waveform voltage, which increases from voltage 0 (V) to voltage Vr2, is applied to scan electrodes SCx and SCy.

Next, an up-ramp waveform voltage which increases from voltage Vp to voltage Vp+Vt2 (=Vr3=Vr2) is generated by adding voltage Vp to the up-ramp waveform voltage which increases from voltage 0 (V) to voltage Vt2. Thus, an up-ramp waveform voltage that is substantially the same as the second up-ramp waveform voltage, which increases from voltage 0 (V) to voltage Vr3, is applied to scan electrode SCy.

At this time, to scan electrode SCx, the up-ramp waveform voltage that increases from voltage 0 (V) to voltage Vt2 is applied without addition of voltage Vp. By setting voltage Vt2 at a voltage that does not cause discharge, the voltage (voltage 0 (V) in the example of FIG. 3) that does not cause discharge is applied to scan electrode SCx. In the present exemplary embodiment, this process is employed because, in the circuit configuration of scan electrode driver circuit 143, it is difficult to apply voltage 0 (V) to scan electrode SCx in the period in which the second up-ramp waveform voltage is applied to scan electrode SCy.

Specifically, in sustain period Ts1 of subfield SF1, scan electrode driver circuit 143 and data electrode driver circuit 42 are operated as follows.

In sustain period Ts1, firstly, switching element Q56 of scan electrode driver circuit 143 is set at OFF, Miller integrating circuit 61 is operated by applying a fixed voltage to input terminal IN61, and an up-ramp waveform voltage which gently increases from voltage 0 (V) to voltage Vr1 is applied to scan electrodes SCx and SCy.

After the up-ramp waveform voltage arrives at voltage Vr1, transistor Q61 of Miller integrating circuit 61 is set at OFF to stop the operation of Miller integrating circuit 61, and switching element Q56 is set at ON to apply voltage 0 (V) to scan electrodes SCx and SCy.

Next, switching elements Q71Lx and Q71Ly are set at OFF and switching elements Q71Hx and Q71Hy are set at ON, thereby applying voltage Vp to scan electrodes SCx and SCy.

Next, switching element Q56 is set at OFF, Miller integrating circuit 62 is operated by applying a fixed voltage to input terminal IN62, and an up-ramp waveform voltage which gently increases from voltage Vp to voltage Vr2 (=Vp+Vt2) is applied to scan electrodes SCx and SCy. Thus, an up-ramp waveform voltage that is substantially the same as the first up-ramp waveform voltage is applied to scan electrodes SCx and SCy.

After the up-ramp waveform voltage arrives at voltage Vr2 (=Vp+Vt2), transistor Q62 of Miller integrating circuit 62 is set at OFF to stop the operation of Miller integrating circuit 62, switching elements Q71Hx and Q71Hy are set at OFF, and switching elements Q71Lx and Q71Ly are set at ON. Thus, the voltages of scan electrodes SCx and SCy decrease from voltage Vr2 to voltage Vt2.

Then, switching element Q56 is set at ON, thereby applying voltage 0 (V) to scan electrodes SCx and SCy.

Next, switching element Q71Ly is set at OFF and switching element Q71Hy is set at ON, thereby applying voltage Vp to scan electrode SCy. Switching element Q71Hx is kept at OFF, and switching element Q71Lx is kept at ON, thereby continuously applying voltage 0 (V) to scan electrode SCx.

Then, switching element Q56 is set at OFF and a fixed voltage is applied to input terminal IN62, thereby operating Miller integrating circuit 62. Thus, an up-ramp waveform voltage which gently increases from voltage Vp to voltage Vr3 (=Vr2=Vp+Vt2) is thus applied to scan electrode SCy. Thus, an up-ramp waveform voltage that is substantially the same as the second up-ramp waveform voltage is applied to scan electrode SCy.

At this time, an up-ramp waveform voltage which gently increases from voltage 0 (V) to voltage Vt2 is applied to scan electrode SCx. However, voltage Vt2 is set at a voltage that does not cause discharge, so that the voltage to be applied to scan electrode SCx becomes a voltage that does not cause discharge (voltage 0 (V) in the example of FIG. 3).

With an appropriate timing in this period, switching elements Q81L1 through Q81Lm are set at OFF while switching elements Q81H1 through Q81Hm of data electrode driver circuit 42 are kept at OFF, thereby putting the output terminal of data electrode driver circuit 42 into a high impedance state. Thus, the voltage of data electrodes D1 through Dm gradually increases with voltage increase of scan electrode SC1 through SCn via the inter-electrode capacity between data electrodes D1 through Dm and scan electrode SC1 through SCn. Thus, the third up-ramp waveform voltage is applied to data electrodes D1 through Dm.

The voltage of data electrodes D1 through Dm when the voltage applied to scan electrode SCy arrives at voltage Vr3 also depends on the timing with which the output terminal of data electrode driver circuit 42 is put into the high impedance state. Therefore, the timing with which the output terminal of data electrode driver circuit 42 is put into the high impedance state is set appropriately so that the voltage of data electrodes D1 through Dm becomes an appropriate value when the voltage applied to scan electrode SCy arrives at voltage Vr3.

When the voltage of data electrodes D1 through Dm arrives at voltage Vd, however, the parasitic diodes of switching elements Q81H1 through Q81Hm come into conduction. Therefore, the voltage of data electrodes D1 through Dm does not continue to increase beyond voltage Vd.

After the up-ramp waveform voltage to be applied to scan electrode SCy arrives at voltage Vr3 (=Vp+Vt2), transistor Q62 of Miller integrating circuit 62 is set at OFF to stop the operation of Miller integrating circuit 62, switching element Q71Hy is set at OFF, and switching element Q71Ly is set at ON. Thus, the voltage of scan electrode SCy decreases from voltage Vr3 to voltage Vt2.

Next, switching element Q56 is set at ON, thereby applying voltage 0 (V) to scan electrodes SCx and SCy. Switching elements Q81L1 through Q81Lm of data electrode driver circuit 42 are set at ON, thereby applying voltage 0 (V) to data electrodes D1 through Dm.

In the first half of initializing period Ti2 of subfield SF2, switching elements Q56 is set at OFF, switching element Q71Lx is set at OFF, and switching element Q71Hx is set at ON, thereby applying voltage Vp to scan electrode SCx. While, switching element Q71Hy is kept at OFF, switching element Q71Ly is kept at ON, thereby continuing to apply voltage 0 (V) to scan electrode SCy.

Then, switching element Q56 is set at OFF and a fixed voltage is applied to input terminal IN61, thereby operating Miller integrating circuit 61. Thus, the fourth up-ramp waveform voltage, which gently increases from voltage Vp to voltage Vi2 (=Vp+Vr1), is applied to scan electrodes SCx.

At this time, an up-ramp waveform voltage which gently increases from voltage 0 (V) to voltage Vr1 is applied to scan electrode SCy. However, by setting voltage Vr1 at a voltage that does not cause initializing discharge, the voltage to be applied to scan electrode SCy becomes a voltage that does not cause discharge (voltage 0 (V) in the example of FIG. 3).

With an appropriate timing in this period, switching elements Q81L1 through Q81Lm of data electrode driver circuit 42 are set at OFF while switching elements Q81H1 through Q81Hm are kept at OFF, thereby putting the output terminal of data electrode driver circuit 42 into a high impedance state. Thus, the voltage of data electrodes D1 through Dm gradually increases with voltage increase of scan electrode SC1 through SCn via the inter-electrode capacity between data electrodes D1 through Dm and scan electrode SC1 through SCn. Thus, the fifth up-ramp waveform voltage is applied to data electrodes D1 through Dm.

The voltage of data electrodes D1 through Dm when the voltage applied to scan electrode SCx arrives at voltage Vi2 also depends on the timing with which the output terminal of data electrode driver circuit 42 is put into the high impedance state. Therefore, the timing with which the output terminal of data electrode driver circuit 42 is put into the high impedance state is set appropriately so that the voltage of data electrodes D1 through Dm becomes an appropriate value when the voltage applied to scan electrode SCx arrives at voltage Vi2.

When the voltage of data electrodes D1 through Dm arrives at voltage Vd, however, the parasitic diodes of switching elements Q81H1 through Q81Hm come into conduction. Therefore, the voltage of data electrodes D1 through Dm does not continue to increase beyond voltage Vd.

After the up-ramp waveform voltage to be applied to scan electrode SCx arrives at voltage Vi2 (=Vp+Vr1), transistor Q61 of Miller integrating circuit 61 is set at OFF to stop the operation of Miller integrating circuit 61, switching element Q71Hx is set at OFF, and switching element Q71Lx is set at ON. Thus, the voltage of scan electrode SCx decreases from voltage Vi2 to voltage Vt1.

Next, switching elements Q56 is set at ON, thereby applying voltage 0 (V) to scan electrodes SCx and SCy. Switching elements Q81L1 through Q81Lm of data electrode driver circuit 42 are set at ON, thereby applying voltage 0 (V) to data electrodes D1 through Dm.

In the latter half of initializing period Ti2, an operation substantially the same as that in initializing period Ti1 is performed. In other words, after switching element Q69 is set at OFF, a fixed voltage is applied to input terminal IN63 of Miller integrating circuit 63 to operate Miller integrating circuit 63, and a down-ramp waveform voltage which gently decreases from voltage 0 (V) to voltage Vi4 is applied to scan electrodes SCx and SCy.

After the down-ramp waveform voltage arrives at voltage Vi4, transistor Q63 of Miller integrating circuit 63 is set at OFF (not shown) to stop the operation of Miller integrating circuit 63.

The operation in address period Tw2 of subsequent subfield SF2 is substantially the same as that in address period Tw1, and hence is not described.

In sustain period Ts2 of subsequent subfield SF2, as many sustain pulses as the number corresponding to the luminance weight are applied to scan electrodes SCx and SCy using sustain pulse generation circuit 50 of scan electrode driver circuit 143.

After the completion of generation of as many sustain pulses as the number corresponding to the luminance weight, switching element Q56 of scan electrode driver circuit 143 is set at OFF, a fixed voltage is applied to input terminal IN61 to operate Miller integrating circuit 61, and the sixth up-ramp waveform voltage, which gently increases from voltage 0 (V) to voltage Vr1, is applied to scan electrodes SCx and SCy.

The following driving voltage waveforms have been described as an example:
the advantage of the driving voltage waveforms is substantially the same as that of the driving voltage waveforms shown in FIG. 3; but
the driving voltage waveforms to be applied to scan electrodes SC1 through SCn are slightly different from those of FIG. 3.

### Third Exemplary Embodiment

The third exemplary embodiment describes an example of driving voltage waveforms substantially similar to those shown in FIG. 10 in the second exemplary embodiment. In this example, however, the driving voltage waveforms to be applied to scan electrodes SC1 through SCn and data electrodes D1 through Dm in the specific-cell initializing period are slightly different from those of FIG. 10.

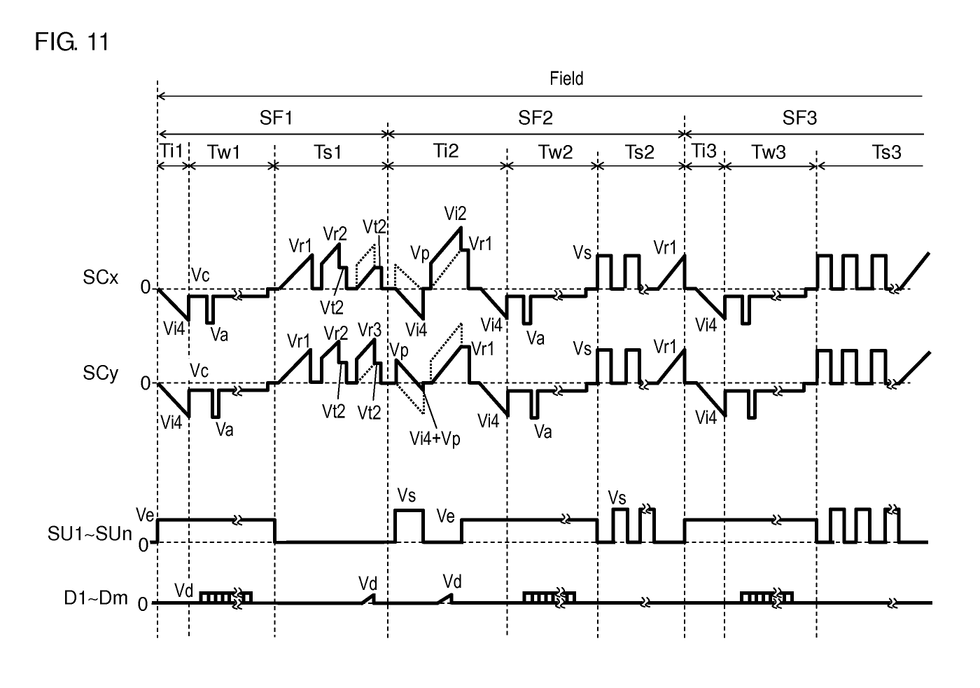

FIG. 11 is a diagram for schematically showing an example of driving voltage waveforms in accordance with the third exemplary embodiment of the present invention.

The driving voltage waveforms of FIG. 11 are different from those of FIG. 10 in the driving voltage waveforms to be applied to scan electrodes SC1 through SCn and data electrodes D1 through Dm in the specific-cell initializing period. The difference is hereinafter described.

In the present exemplary embodiment, in initializing period Ti2 of subfield SF2, to scan electrode SCx to undergo a forced initializing operation, a down-ramp waveform voltage which gently decreases from voltage 0 (V) to voltage Vi4 is applied before the fourth up-ramp waveform voltage. In this period, voltage Vs is applied to sustain electrode SU1 through SUn.

Thus, prior to initializing discharge where data electrode 32 that hardly emits electrons is used as a negative electrode, the discharge occurs where scan electrode SCx apt to emit electrons is used as a negative electrode and sustain electrode SUx is used as a positive electrode. Therefore, in the forced initializing operation performed immediately afterward, initializing discharge where data electrode 32 is used as a negative electrode can be stably caused, and false discharge can be prevented.

To sustain electrode SCy to undergo a selective initializing operation immediately afterward, a voltage that does not cause discharge is applied while the above-mentioned down-ramp waveform voltage is applied to scan electrode SCx. This process is performed so as to prevent false discharge from occurring in the selective initializing operation. The applied voltage may be a voltage derived by adding a predetermined positive voltage (e.g. voltage Vp) to the down-ramp waveform voltage to be applied to scan electrode SCx, for example as shown in FIG. 11. In other words, the applied voltage may be a down-ramp waveform voltage which decreases from voltage Vp to voltage Vp+Vi4. Alternatively, the applied voltage may be voltage 0 (V). The applied voltage may be any voltage as long as the voltage does not cause discharge in the discharge cell where a selective initializing operation is performed immediately afterward.

In the driving voltage waveforms of FIG. 11, the fifth up-ramp waveform voltage applied to data electrodes D1 through Dm may be omitted.

### Fourth Exemplary Embodiment

The fourth exemplary embodiment describes an example of driving voltage waveforms substantially similar to those shown in FIG. 11 in the third exemplary embodiment. In this example, however, the driving voltage waveforms to be applied to scan electrodes SC1 through SCn and data electrodes D1 through Dm in the specific-cell initializing period are slightly different from those of FIG. 11.

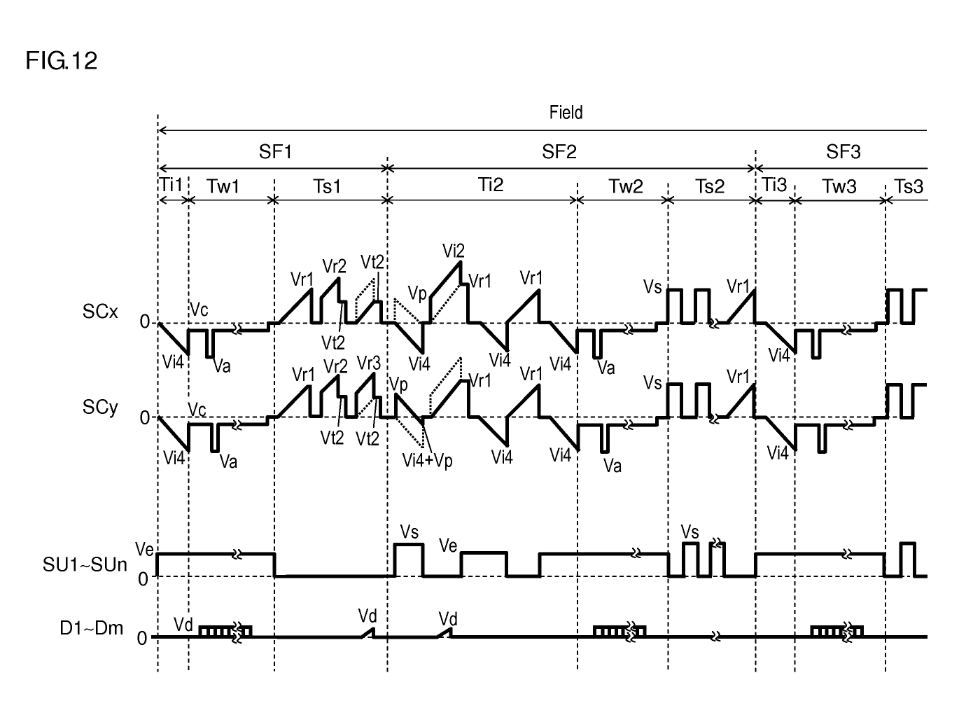

FIG. 12 is a diagram for schematically showing an example of driving voltage waveforms in accordance with the fourth exemplary embodiment of the present invention.

The driving voltage waveforms of FIG. 12 are different from those of FIG. 11 in the driving voltage waveforms to be applied to scan electrodes SC1 through SCn and data electrodes D1 through Dm in the specific-cell initializing period. The difference is described below.

In the present exemplary embodiment, in initializing period Ti2 of subfield SF2, after the forced initializing operation and selective initializing operation of FIG. 10, an up-ramp waveform voltage which gently increases from voltage 0 (V) to voltage Vr1 is applied to scan electrodes SC1 through SCn, then a down-ramp waveform voltage which gently decreases from voltage 0 (V) to voltage Vi4 is applied to them. While the down-ramp waveform voltage is applied to scan electrodes SC1 through SCn, voltage Ve is applied to sustain electrodes SU1 through SUn.

Thus, even if false discharge occurs in the initializing period in which a specific-cell initializing operation is performed, initializing discharge can be caused again in the discharge cell having undergone the false discharge. Therefore, initializing discharge can be caused further stably, and the image display quality can be further improved in the plasma display apparatus.

### Fifth Exemplary Embodiment

The first through fourth exemplary embodiments have described the configurations where a weak-discharge sustain operation subfield is included in one field. However, a configuration may be employed which, in response to an image signal or image display mode, switches between the following modes:
panel 10 is driven while a weak-discharge sustain operation subfield is included in one field; and
panel 10 is driven while no weak-discharge sustain operation subfield is included in one field.

One example of the configuration that switches between the modes of driving panel 10 in response to the image signal can be described below.

1. When an image signal such as a movie having much relatively dark video is displayed on panel 10, panel 10 is driven using a weak-discharge sustain operation subfield that enables dark gradations to be displayed.
2. When an image signal such as a studio movie having much relatively bright video is displayed on panel 10, panel 10 is driven without using a weak-discharge sustain operation subfield.

One example of the configuration that switches between the modes of driving panel 10 in response to the image display mode can be described below.

1. Panel 10 is driven without using a weak-discharge sustain operation subfield in typical standard mode or in dynamic mode where high priority is given to display of an image at high contrast.
2. Panel 10 is driven using a weak-discharge sustain operation subfield in cinema mode where high priority is given to smoothness of the display image and a large number of gradations.

At this time, for example, the gradient of the down-ramp waveform voltage generated in the initializing period of a specific-cell initializing subfield may depend on which of a weak-discharge sustain operation and a strong-discharge sustain operation is performed in the sustain period of the subfield immediately before the specific-cell initializing subfield.

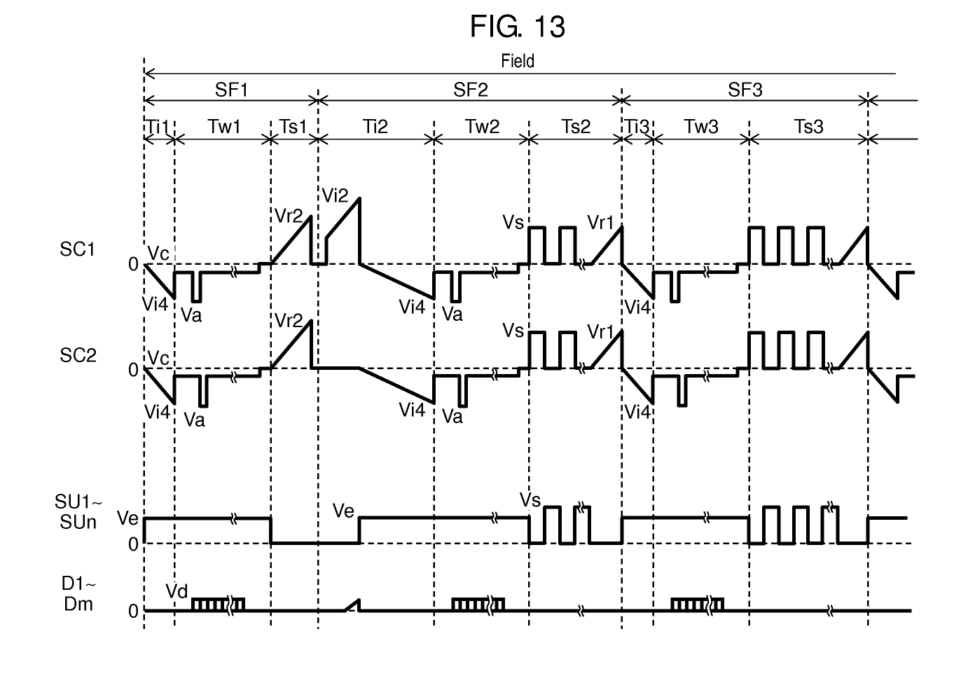

FIG. 13 is a diagram for schematically showing an example of driving voltage waveforms in accordance with a fifth exemplary embodiment of the present invention.

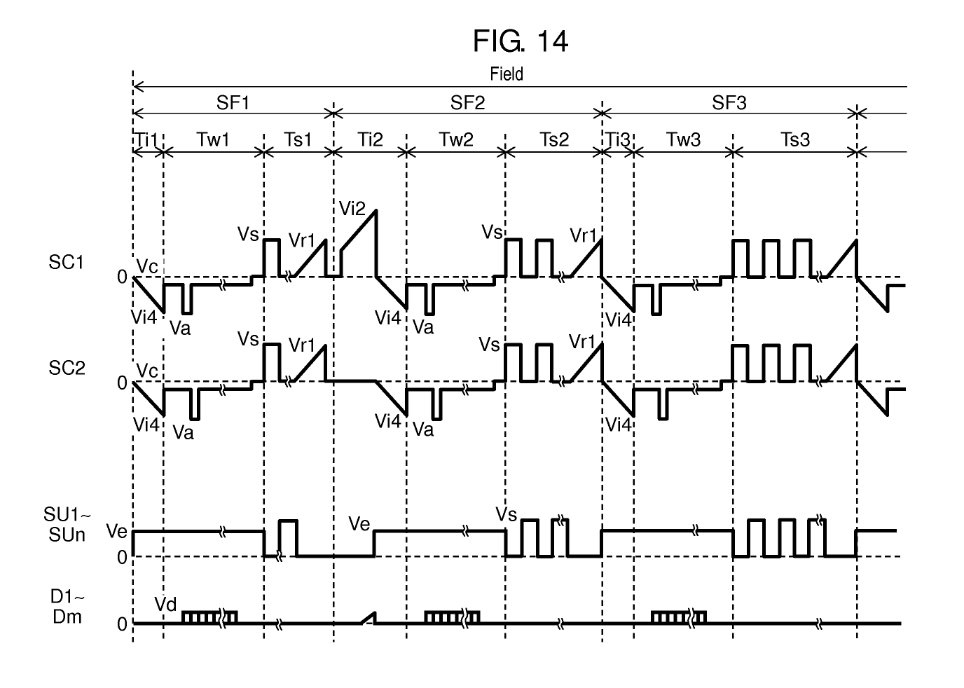

FIG. 14 is a diagram for schematically showing another example of driving voltage waveforms in accordance with the fifth exemplary embodiment of the present invention.

FIG. 13 shows an example of driving voltage waveforms when a weak-discharge sustain operation is performed in the sustain period of subfield SF1. FIG. 14 shows an example of driving voltage waveforms when a strong-discharge sustain operation is performed in the sustain period of subfield SF1.

In the present exemplary embodiment, as shown in FIG. 13, when a weak-discharge sustain operation is performed in the sustain period of the subfield immediately before the specific-cell initializing subfield, the gradient of the down-ramp waveform voltage generated in the initializing period of the specific-cell initializing subfield is made gentler than that in the initializing periods (selective initializing periods) of the other subfields.

In the present exemplary embodiment, in this case, the gradient of the down-ramp waveform voltage generated in the initializing period of the specific-cell initializing subfield is set at approximately −1.0 (V/μsec), and the gradient of the down-ramp waveform voltage generated in the initializing periods (selective initializing periods) of the other subfields is set at approximately −2.5 (V/μsec), for example.

In the present exemplary embodiment, in FIG. 14, when a strong-discharge sustain operation is performed in the sustain period of the subfield immediately before the specific-cell initializing subfield, the gradient of the down-ramp waveform voltage generated in the initializing period of the specific-cell initializing subfield is made the same as that in the initializing periods (selective initializing periods) of the other subfields.

In the present exemplary embodiment, the gradient of the down-ramp waveform voltage generated in the initializing period of the specific-cell initializing subfield, and the gradient of the down-ramp waveform voltage generated in the initializing periods (selective initializing periods) of the other subfields are set at approximately −2.5 (V/μsec), for example.

The reason for this is described below.

For example, when the gradation that causes light emission only in subfield SF1 as a weak-discharge sustain operation subfield is continuously displayed on panel 10, the number of priming particles generated by the weak-discharge sustain operation becomes relatively small. Therefore, initializing discharge occurs relatively hardly in the subsequent initializing operation.

Specifically, when the number of priming particles becomes small, the period (discharge delay period) after the voltage applied to the discharge cell exceeds the discharge start voltage until discharge actually occurs becomes long.

If the discharge delay period becomes long when a ramp waveform voltage is applied to cause discharge in the discharge cell, the voltage applied to the discharge cell increases in the period after the voltage applied to the discharge cell exceeds the discharge start voltage until discharge actually occurs, and strong discharge can occur in the discharge cell.

In order to prevent such strong discharge, the gradient of the ramp waveform voltage applied to the discharge cell is made gentle as much as possible.

In the present exemplary embodiment, therefore, when a weak-discharge sustain operation is performed in the sustain period of the subfield immediately before the specific-cell initializing subfield, the gradient of the down-ramp waveform voltage generated in the initializing period of the specific-cell initializing subfield is set at a value that is gentler than that in the initializing periods (selective initializing periods) of the other subfields. Here, this value is −1.0 (V/μsec), for example.

While, the following phenomenon has been recognized:
in a strong-discharge sustain operation performed in the sustain period of the subfield immediately before the specific-cell initializing subfield, if the gradient of the down-ramp waveform voltage generated in the latter half of the initializing period of the specific-cell initializing subfield is gentle, the subsequent address operation becomes unstable.

This phenomenon is considered to occur because the duration of the initializing discharge is extended by making the gradient of the down-ramp waveform voltage gentle, and the wall voltage for an address operation excessively decreases.

In the present exemplary embodiment, therefore, when a strong-discharge sustain operation is performed in the sustain period of the subfield immediately before the specific-cell initializing subfield, the gradient of the down-ramp waveform voltage generated in the initializing period of the specific-cell initializing subfield is set at a value that is the same as that in the initializing periods (selective initializing periods) of the other subfields. Here, this value is −2.5 (V/μsec), for example.

Thus, in the present exemplary embodiment, the gradient of the down-ramp waveform voltage generated in the initializing period of the specific-cell initializing subfield depends on which of a weak-discharge sustain operation and a strong-discharge sustain operation is performed in the sustain period of the subfield immediately before the specific-cell initializing subfield. Thus, discharge after the specific-cell initializing subfield can be caused stably.

FIG. 13 showing an example of the present exemplary embodiment has shown the case where only the first up-ramp waveform voltage, which increases from voltage 0 (V) to voltage Vr2, is applied to scan electrodes SC1 through SCn in sustain period Ts1 of subfield SF1 as a weak-discharge sustain operation subfield. However, the present invention is not limited to this configuration. The configuration of the fifth exemplary embodiment can be applied to the driving voltage waveforms of each of the first through fourth exemplary embodiments, and can provide an advantage similar to that of each of the first through fourth exemplary embodiments. The third and fourth exemplary embodiments have described the configurations where a plurality of down-ramp waveform voltages is generated in initializing period Ti2 to perform a specific-cell initializing operation. The configuration of the fifth exemplary embodiment may be applied to one or more of the down-ramp waveform voltages.

The exemplary embodiments of the present invention have described an example where, to the discharge cell to which the second up-ramp waveform voltage is applied, the first up-ramp waveform voltage is applied immediately before the application. The present invention is not limited to this configuration. For example, the following configuration may be employed:
to the discharge cell to undergo the second up-ramp waveform voltage, a voltage (e.g. voltage 0 (V)) that does not cause discharge is applied instead of the first up-ramp waveform voltage.
   In other words, the following configuration may be employed:
in the discharge cell to undergo a selective initializing operation in the specific-cell initializing subfield (e.g. subfield SF2) immediately after a weak-discharge sustain operation subfield (e.g. subfield SF1), in the sustain period (e.g. sustain period Ts1) of the weak-discharge sustain operation subfield, a voltage (e.g. voltage 0 (V)) that does not cause discharge is applied and then the second up-ramp waveform voltage is applied.

The exemplary embodiments of the present invention have described an example where the discharge cell to undergo a forced initializing operation in the specific-cell initializing subfield is set based on (Rule 1) and (Rule 2). The present invention is not limited to this configuration, and these rules may be modified. For example, instead of (Rule 2), rule “the number of scan electrodes where a forced initializing operation is performed in one field is one or zero in each scan electrode group” may be used.

The exemplary embodiments have described an example where the first voltage (voltage Vr2) is set higher than the third voltage (voltage Vr1). This setting is performed in order that the first voltage (voltage Vr2) is set high as much as possible in a range where discharge by the first up-ramp waveform voltage does not occur in the discharge cell having undergone no address discharge in address period Tw1 of subfield SF1, and the variation in discharge intensity of the address discharge between the discharge cells is reduced.

The number of subfields constituting one field, the generation sequence of the subfields, and the luminance weight of each subfield of the present invention are not limited to the above-mentioned configurations. The subfield to perform a forced initializing operation and the subfield to perform a selective initializing operation are not limited to the above-mentioned subfields, either. Preferably, they are set optimally in response to the specification or the like of the plasma display apparatus. The subfield structure may be changed based on an image signal or the like.

The driving voltage waveforms of FIG. 3, FIG. 10, FIG. 11, FIG. 12, FIG. 13, and FIG. 14 are simply one example of the exemplary embodiments of the present invention, and the present invention is not limited to these driving voltage waveforms.

The circuit configurations of FIG. 5, FIG. 6, FIG. 7, FIG. 8, and FIG. 9 are also simply one example of the exemplary embodiments of the present invention, and the present invention is not limited to these circuit configurations.

The scan electrodes to undergo a forced initializing operation in the specific-cell initializing subfield in FIG. 4 is also simply one example of the exemplary embodiments of the present invention, and the present invention is not limited to this configuration.

Each circuit block shown in the exemplary embodiments of the present invention may be configured as an electric circuit for performing each operation shown in the exemplary embodiments, or may be configured using a microcomputer or computer programmed so as to perform a similar operation.

In the exemplary embodiments of the present invention, an example where one field is constituted by 10 subfields has been described. In the present invention, however, the number of subfields constituting one field is not limited to the above-mentioned value. For example, when the number of subfields is increased, the number of gradations displayable on panel 10 can be further increased. When the number of subfields is decreased, the time required for driving panel 10 can be shortened.

In the exemplary embodiments of the present invention, an example where one pixel is formed of discharge cells of three colors, namely red, green, and blue, has been described. However, also in a panel where one pixel is formed of discharge cells of four or more colors, the configurations shown in the exemplary embodiments of the present invention can be applied and a similar advantage can be provided.

Each specific numerical value shown in the exemplary embodiments of the present invention is set based on the characteristics of panel 10 having a screen size of 50 inches and having 1024 display electrode pairs 24, and is simply one example in the exemplary embodiments. The present invention is not limited to these numerical values. Numerical values are preferably set optimally in response to the specification and characteristics of the panel and the specification of the plasma display apparatus. These numerical values can vary in a range allowing the above-mentioned advantage. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

In the present invention, the contrast of a display image can be increased by further finely displaying gradations in a dark region of the display image and by reducing the luminance of black level, and address discharge can be caused stably. The present invention is useful as a driving method of a plasma display panel and as a plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35, 35R, 35G, 35B phosphor layer
40 plasma display apparatus
41 image signal processing circuit
42 data electrode driver circuit
43, 143 scan electrode driver circuit
44 sustain electrode driver circuit
45 timing generation circuit
51, 81 power recovery circuit
50, 80 sustain pulse generation circuit
60, 160 ramp waveform voltage generation circuit
61, 62, 63 Miller integrating circuit
70 scan pulse generation circuit
85 fixed-voltage generation circuit
Di11, Di12, Di21, Di22, Di62 diode
L11, L12, L21, L22 inductor
Q11, Q12, Q21, Q22, Q55, Q56, Q59, Q69, Q72, Q83, Q84, Q86, Q87, Q71H1 through Q71Hn, Q71L1 through Q71Ln, Q91H1 through Q91Hm, Q91L1 through Q91Lm switching element
C10, C20, C61, C62, C63 capacitor
R61, R62, R63 resistor
Q61, Q62, Q63 transistor
IN61, IN62, IN63 input terminal
E71 power supply

1. A driving method of a plasma display panel including a plurality of discharge cells each of which includes a scan electrode, a sustain electrode, and a data electrode, the driving method comprising:
forming a plurality of subfields in one field, each of the subfields having an initializing period, an address period, and a sustain period;
making the subfields include a weak-discharge sustain operation subfield in which no sustain pulse is generated in the sustain period;
in the initializing period of the subfield immediately after the weak-discharge sustain operation subfield, performing at least one of
a forced initializing operation of causing an initializing discharge in the discharge cells regardless of presence or absence of a discharge in the weak-discharge sustain operation subfield, and
a selective initializing operation of causing an initializing discharge only in a discharge cell having undergone an address discharge in the weak-discharge sustain operation subfield;
applying a first up-ramp waveform voltage, which increases from a base potential to a first voltage, to the scan electrode and then applying a voltage causing no discharge to the scan electrode, in the sustain period of the weak-discharge sustain operation subfield in a discharge cell that is to be subjected to the forced initializing operation in the initializing period of the subfield immediately after the weak-discharge sustain operation subfield; and
applying a second up-ramp waveform voltage, which increases from the base potential to a second voltage, to the scan electrode after generation of the first up-ramp waveform voltage, in the sustain period of the weak-discharge sustain operation subfield in a discharge cell that is to be subjected to the selective initializing operation in the initializing period of the subfield immediately after the weak-discharge sustain operation subfield.

2. The driving method of the plasma display panel of claim 1, wherein
the base potential is applied to the data electrodes when the first up-ramp waveform voltage is applied to the scan electrodes, and a third up-ramp waveform voltage is applied to the data electrodes when the second up-ramp waveform voltage is applied to the scan electrodes.

3. The driving method of the plasma display panel of claim 2, wherein
the second voltage is set at the first voltage or lower.

4. The driving method of the plasma display panel of claim 1, wherein
a down-ramp waveform voltage is applied to the scan electrodes in the initializing period, and
a gradient of the down-ramp waveform voltage in the initializing period of the subfield immediately after the weak-discharge sustain operation subfield is set gentler than a gradient of the down-ramp waveform voltage in the initializing periods of the other subfields.

5. A plasma display apparatus comprising:
a plasma display panel including a plurality of discharge cells, each of the discharge cells including a scan electrode, a sustain electrode, and a data electrode; and
a driver circuit for driving the plasma display panel by forming a plurality of subfields in one field, each of the subfields having an initializing period, an address period, and a sustain period,
wherein
the driver circuit makes the subfields include a weak-discharge sustain operation subfield in which no sustain pulse is generated in the sustain period,
in the initializing period of the subfield immediately after the weak-discharge sustain operation subfield, the driver circuit performs at least one of
a forced initializing operation of causing an initializing discharge in the discharge cells regardless of presence or absence of a discharge in the weak-discharge sustain operation subfield, and
a selective initializing operation of causing an initializing discharge only in a discharge cell having undergone an address discharge in the weak-discharge sustain operation subfield,
the driver circuit applies a first up-ramp waveform voltage, which increases from a base potential to a first voltage, to the scan electrode and then applies a voltage causing no discharge to the scan electrode, in the sustain period of the weak-discharge sustain operation subfield in a discharge cell that is to be subjected to the forced initializing operation in the initializing period of the subfield immediately after the weak-discharge sustain operation subfield, and
the driver circuit applies a second up-ramp waveform voltage, which increases from the base potential to a second voltage, to the scan electrode after generation of the first up-ramp waveform voltage, in the sustain period of the weak-discharge sustain operation subfield in a discharge cell that is to be subjected to the selective initializing operation in the initializing period of the subfield immediately after the weak-discharge sustain operation subfield.
